(19) United States
(12) Patent Application Publication
(10) Pub. No.: US 2014/0074535 A1
(43) Pub. Date: Mar. 13, 2014

(54) SYSTEM AND METHOD FOR ALARM AND CALENDAR EVENT MANAGEMENT

(71) Applicant: Vee-How Philip WOO-KWAN-CHUNG, Hong Kong (HK)

(72) Inventor: Vee-How Philip WOO-KWAN-CHUNG, Hong Kong (HK)

(21) Appl. No.: 13/922,267

(22) Filed: Jun. 20, 2013

Related U.S. Application Data
(60) Provisional application No. 61/698,734, filed on Sep. 10, 2012.
(60) Provisional application No. 61/768,578, filed on Feb. 25, 2013.
(60) Provisional application No. 61/803,809, filed on Mar. 21, 2013.

(51) Int. Cl. G06Q 10/10

(52) U.S. Cl. CPC G06Q 10/1095
USPC 705/7.19

(57) ABSTRACT

An alarm and calendar event management system for a mobile device includes: means for setting up a plurality of recurring alarms through one single recurring alarm setup, the recurring alarm being configured to fire at a predetermined date and time periodically; means for downloading and recognizing a plurality of country holidays of a country that matches the time zone in which the mobile device is physically located; means for selectively disabling the recurring alarm on a date based on the country holidays or a configuration of a user without altering the single recurring alarm setup; and means for selectively reinstating the recurring alarm on a date based on a configuration of the user without altering the single recurring alarm setup.

### CROSS-REFERENCE TO RELATED APPLICATIONS

This application claims the benefits of U.S. Provisional Patent Application No. 61/698,734 filed on Sep. 10, 2012, U.S. Provisional Patent Application No. 61/768,578 filed on Feb. 23, 2013, and U.S. Provisional Patent Application No. 61/803,809 filed on Mar. 21, 2013, the contents of which are hereby incorporated by reference.

### FIELD OF THE PATENT APPLICATION

The present patent application generally relates to mobile computing technologies and more specifically to a system and a method for managing alarms and calendar events in mobile devices.

### BACKGROUND

Users of mobile devices, as part of their daily routines, use alarm and calendar event features for their intended purposes as separate applications that are mutually independent of each other. For instance, users can set up appointments, reminders, and anniversaries for specific calendar dates, set up alarms with or without weekly repeat frequencies. In particular, with respect to alarm and calendar event management, whenever the need arises to prevent an unwanted alarm to fire, users do so by updating or switching off recurring alarm setting on a timely basis right before each unwanted alarm's firing occurrence and switching back on the alarm's original settings afterwards.

### SUMMARY

The present patent application is directed to an alarm and calendar event management system for a mobile device. In one aspect, the system includes: means for setting up a plurality of recurring alarms through one single recurring alarm setup, each recurring alarm being configured to fire at a predetermined date and time periodically; means for downloading a plurality of country holidays of a country that matches the mobile device's current time zone in which the mobile device is physically located; means for automatically recognizing a plurality of previously downloaded country holidays of a country that matches the mobile device's current time zone in which the mobile device is physically located; means for setting up a plurality of personal holidays; means for selectively disabling the recurring alarms on a date based on the country holidays, the personal holidays, or a configuration of a user without altering the single recurring alarm setup; means for selectively reinstating the recurring alarms on a date based on a configuration of the user without altering the single recurring alarm setup; and means for synchronizing the recurring alarms and related calendar triggered events with other mobile devices.

The country holidays may be associated with the same calendar year as the mobile device's operating system, and downloaded from a remote server. The means for selectively disabling the recurring alarms may be configured either to disable the recurring alarms on all the country holidays, or to allow the recurring alarms on all the country holidays. The alarm and calendar event management system may further include means for determining a subset of the country holidays as generally observed country holidays based on a built-in holiday rules engine, a user's preset criteria, and time zone information of the mobile device. The means for selectively disabling the recurring alarms may be configured to disable the recurring alarms on all generally observed country holidays.

The means for selectively disabling the recurring alarms may be configured to enable the user to disable the recurring alarms on a specific date via a virtual calendar month display view. The means for selectively reinstating the recurring alarms may be configured to enable the user to reinstate the recurring alarms on a specific date via a virtual calendar month display view.

The alarm and calendar event management system may further include means for establishing a universal alarm setting. The means for setting up the recurring alarms may be configured to set up new recurring alarms inheriting the universal alarm setting. The universal alarm setting may include a snooze parameter, a sound parameter, a volume setting, and a vibrate setting.

The means for setting up the recurring alarms may be configured to configure the recurring alarms to fire in a plurality of periodical shift cycles in a looped fashion, on dates corresponding to fixed chronological days in each shift cycle, and at a time that is associated with an individual periodic shift cycle that is prevailing on the day of the recurring alarm firing.

The means for selectively disabling the recurring alarms may be configured to disable the recurring alarms on a specific date by an instruction from the user through voice interaction, and the means for selectively reinstating the recurring alarms may be configured to reinstate the recurring alarms on a specific date by an instruction from the user through voice interaction.

The alarm and calendar event management system may further include means for synchronizing a user data instance with a cloud based server. The user data instance may be a consolidated data file that primarily holds a set of recurring alarm events and related calendar events that impact such recurring alarm events.

The means for synchronizing the user data instance may be configured to authenticate a user by recognizing a predetermined controlling user authentication profile, and to synchronize the user data instance with mobile devices that share similar controlling user authentication profiles.

In another aspect, the present patent application provides an alarm and calendar event management method for a mobile device. The method includes: setting up a plurality of recurring alarms through one single recurring alarm setup, each recurring alarm being configured to fire at a predetermined date and time periodically; downloading a plurality of country holidays of a country that matches the mobile device's current time zone in which the mobile device is physically located; setting up a plurality of personal holidays; selectively disabling the recurring alarms on a date based on the country holidays, the personal holidays, or a configuration of a user without altering the single recurring alarm setup; and selectively reinstating the recurring alarms on a date based on a configuration of the user without altering the single recurring alarm setup.

The country holidays may be associated with the same calendar year as the mobile device's operating system, and downloaded from a remote server. In the step of selectively disabling the recurring alarm, the recurring alarms on all the country holidays may be disabled or allowed.

The alarm and calendar event management method may further include determining a subset of the country holidays as generally observed country holidays based on a built-in holiday rules engine, a user's preset criteria, and time zone information of the mobile device. The step of selectively disabling the recurring alarms may include disabling the recurring alarms on all generally observed country holidays.

The step of selectively disabling the recurring alarms may include enabling the user to disable the recurring alarms on a specific date via a virtual calendar month display view, and the step of selectively reinstating the recurring alarms may include enabling the user to reinstate the recurring alarms on a specific date via a virtual calendar month display view.

In the step of setting up the recurring alarms, the recurring alarms may be configured to fire in a plurality of periodical shift cycles in a looped fashion, on user's selected dates that coincide with the mobile device's current system dates, of any respective periodical shift cycle that is currently prevailing at time of the recurring alarms' firing, and at user's specified time associated with the respective periodic shift cycle.

In yet another aspect, the present patent application provides an alarm and calendar event management system for a mobile device. The system includes: means for setting up a recurring alarm through one single recurring alarm setup, the recurring alarm being configured to fire at a predetermined date and time periodically; means for downloading a plurality of country holidays of a country that matches the time zone in which the mobile device is physically located; means for selectively disabling the recurring alarm on a date based on the country holidays or a configuration of a user without altering the single recurring alarm setup; and means for selectively reinstating the recurring alarm on a date based on a configuration of the user without altering the single recurring alarm setup.

The means for selectively disabling the recurring alarm may be configured either to disable the recurring alarm on all the country holidays, or to allow the recurring alarm on all the country holidays.

The means for setting up the recurring alarm may be configured to configure the recurring alarm to fire in a plurality of periodical shift cycles in a looped fashion, on dates corresponding to fixed chronological days in each shift cycle, and at a time that is associated with an individual periodic shift cycle that is prevailing on the day of the recurring alarm firing.

### BRIEF DESCRIPTIONS OF THE DRAWINGS

FIG. 1 illustrates an exemplary use of an alarm and calendar event management system for a mobile device according to an embodiment of the present patent application.

FIG. 2 shows an alarm and calendar event management system for a mobile device with a screen display that displays an illustrative user interface with functions available to a user after the alarm and calendar event management system has started up successfully.

FIG. 3 is a flowchart illustrating an exemplary process of determining a currently active time zone of an alarm and calendar event management system based on a mobile device's currently active time zone according to another embodiment of the present patent application.

FIG. 4 is a flowchart illustrating an exemplary process of determining currently active country holidays based on the alarm and calendar event management system's currently active time zone, executed on the alarm and calendar event management system.

FIG. 5 is a flowchart illustrating an exemplary process of determining currently active generally observed country holidays based on the alarm and calendar event management system's built-in country holidays rule engine, the mobile device user's preset criteria, and the alarm and calendar event management system's currently active time zone, executed on the alarm and calendar event management system.

FIG. 6A is a schematic view of functions and notifications associated with detecting the active time zone, country holidays, and generally observed country holidays and the related processes.

FIG. 6B is another schematic view of functions and notifications associated with detecting the active time zone, country holidays, and generally observed country holidays and the related processes.

FIG. 7 is a schematic view of an exemplary illustrative user interface through which a user can set up the alarm and calendar event management system's Universal Alarm Setting according to another embodiment of the present patent application.

FIG. 8 shows a mobile device with a screen display that displays an illustrative user interface with functions available to a user during the firing execution of a specific type of alarm.

FIG. 9A shows an illustrative user interface with a schematic view of functions available to a user for creating a recurring alarm and/or editing an existing recurring alarm of a non-shift cycle nature according to another embodiment of the present patent application.

FIG. 9B shows an illustrative user interface showing a recurring alarm block that represents an existing non-shift cycle related recurring alarm record according to the embodiment depicted in FIG. 9A.

FIG. 9C shows an illustrative user interface with a schematic view of functions available to a user for creating a recurring alarm and/or editing an existing recurring alarm of a shift cycle nature according to another embodiment of the present patent application.

FIG. 9D shows an illustrative user interface showing a recurring alarm block that represents an existing shift cycle related recurring alarm record according to the embodiment depicted in FIG. 9C.

FIG. 10 shows an illustrative user interface with a schematic view of a listing of skipped recurring alarms in accordance with another embodiment of the present patent application.

FIG. 11 shows an illustrative user interface with a schematic view of functions available to a mobile device user for creating a personal alarm or editing/deleting an existing personal alarm in accordance with another embodiment of the present patent application.

FIG. 12 is a flowchart illustrating an exemplary process of downloading country holidays for a mobile device user's specific country and calendar year, executed in the alarm and calendar event management system in accordance with another embodiment of the present patent application.

FIG. 13A shows a mobile device with a screen display that displays an illustrative user interface with functions to allow a mobile device user to download country holidays for a specific country and a calendar year, as well as to edit country holidays related information.

FIG. 13B shows a mobile device with a screen display that displays an illustrative user interface that provides functions available to a mobile device user to further identify generally observed country holiday based on a country holiday's attribute.

FIG. 14 is a block diagram illustrating an exemplary process of viewing and editing downloaded country holidays for a specific country and calendar year, executed on the alarm and calendar event management system.

FIG. 15 shows a mobile device with a screen display that displays an illustrative user interface for viewing individual downloaded country holidays for specific country and calendar year along with a schematic view of functions available to a user to edit individual information in accordance with another embodiment of the present patent application.

FIG. 16 is a flow chart illustrating a process of creating a user's personal holiday, including an option to trigger a mechanism to skip an active recurring alarm in the personal holiday's duration, executed by an alarm and calendar event management system according to another embodiment of the present patent application.

FIG. 17 shows an illustrative user interface with a schematic view of functions available to a user for creating a new personal holiday or editing/deleting existing personal holiday(s) with default activation trigger switch for preventing unwanted recurring alarms in accordance with another embodiment of the present patent application.

FIG. 18 shows an illustrative of virtual calendar month interface with touch sensitive date cells, a date cell being the target date with its daily calendar pop window along with a specific calendar event all being displayed on the mobile device in accordance with another embodiment of the present patent application.

FIG. 19 is a flowchart illustrating a process of skipping or reinstating of an active recurring alarm via a virtual calendar monthly view, executed by an alarm and calendar event management system according to another embodiment of the present patent application.

FIG. 20 shows a mobile device with a screen display that displays an illustrative user interface showing a touch sensitive calendar event for a specific target date, displayed within a calendar event pop-up window that further sits on top of a virtual calendar month view display with a specific date cell representing a specific target date with no skipped active recurring alarm triggered for the target date.

FIG. 21 shows a mobile device with a screen display that displays an illustrative user interface showing individual touch sensitive calendar event for a specific target date, being displayed within a calendar event pop-up window that further sits on top of a virtual calendar month view display with a specific date cell representing the target date that currently holds a skipped active recurring alarm indicated by an appropriate marker triggered for the target date.

FIG. 22 is an illustrative user interface of an alarm and calendar event management system initiating an appropriate voice-enabled recognition and interaction program to skip or reinstate a particular recurring alarm for a specific calendar date through voice interaction means between the user and the alarm and calendar event management system via the mobile device's audio system.

FIG. 22A is an illustrative user interface during the execution of the alarm and calendar event management system's skipping active recurring alarm voice interaction request program for the purpose of disabling an active recurring alarm for a specific calendar date, arising from the mobile device user's request.

FIG. 22B is an illustrative user interface during the execution of the alarm and calendar event management system's reinstating of an active recurring alarm voice interaction request program for the purpose of reinstating of an active recurring alarm for a specific calendar date, arising from the user's request.

FIG. 23A shows a mobile device with a screen display that displays an illustrative user interface with functions relating to the creation of Non-biometric Controlling User Authentication Profile for the purpose of synchronization activities or user access control to the alarm and calendar event management system.

FIG. 23B shows a mobile device with a screen display that displays an illustrative user interface with functions relating to the creation of a Biometric Controlling User Authentication Profile for the purpose of synchronization activities or user access control to the alarm and calendar event management system.

FIG. 24 shows a mobile device with a screen display that displays an illustrative user interface with functions relating to the synchronization related activities and user access control to the alarm and calendar event management system through the Controlling UAP according to another embodiment of the present patent application.

### DETAILED DESCRIPTION

Reference will now be made in detail to a preferred embodiment of the system and the method for alarm and calendar event management disclosed in the present patent application, examples of which are also provided in the following description. Exemplary embodiments of the system and the method for alarm and calendar event management disclosed in the present patent application are described in detail, although it will be apparent to those skilled in the relevant art that some features that are not particularly important to an understanding of the system and the method for alarm and calendar event management may not be shown for the sake of clarity.

Furthermore, it should be understood that the system and the method for alarm and calendar event management disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

The present patent application provides a unified alarm and calendar event management system for a mobile device that is operable to provide a single, unified and integrated application (also referred to as the “single application” or the “integrated application”, the terms being used interchangeably with the “alarm and calendar event management system” throughout the present patent application) with functions available to a mobile device user, involving processing the user's action(s) (i.e. a single or a group of actions) with the purpose of creating and managing alarm and calendar based events. For instance, the mobile device user may engage touch sensitive components of the alarm and calendar event management system, which are a part of a responsive mobile device display of the mobile device. When the mobile device user engages (for example, touches) the touch sensitive components, such engagement is interpreted by the alarm and calendar event management system, after which the alarm and calendar event management system responds accordingly to the user's action(s).

Throughout this patent application, when referring to that a date (or a range of dates) on which an alarm or calendar based event (e.g. a recurring alarm, a personal alarm, a personal holiday, a country holiday, etc.), in conjunction with or without specific prevailing conditions, is programmed to take place or be skipped, it is implied and understood that such a date (or range of dates) is coinciding with the operating system's current date of the mobile device. It is understood that the alarm and calendar event management system is configured to rely on the mobile device's internal clock and calendar date system to identity the alarm and calendar event management system's current time, calendar days, and calendar dates for the purpose of managing individual alarms and other calendar events (e.g. for recurring alarms, personal alarms, schedule reminders, anniversaries, country holidays, personal holidays). The mobile device's internal clock and calendar date system are tied to a mobile device's currently active time zone that, in turn, may have been fetched from different sources including geo-positioning systems, cellular service networks depending on the mobile device's mode of operation (3G, GPRS, 4G or any prevailing network standard), or manually set by the user.

According to an embodiment of the present patent application, an alarm and calendar event management system for a mobile device includes: means for setting up a plurality of recurring alarms, each recurring alarm being configured to fire at a predetermined date and time periodically; means for downloading a plurality of country holidays of a country that matches the time zone in which the mobile device is physically located; means for setting up a plurality of personal holidays; means for selectively disabling the recurring alarms on a date based on the country holidays, the personal holidays, or a configuration of a user; and means for selectively reinstating the recurring alarms on a date based on a configuration of the user.

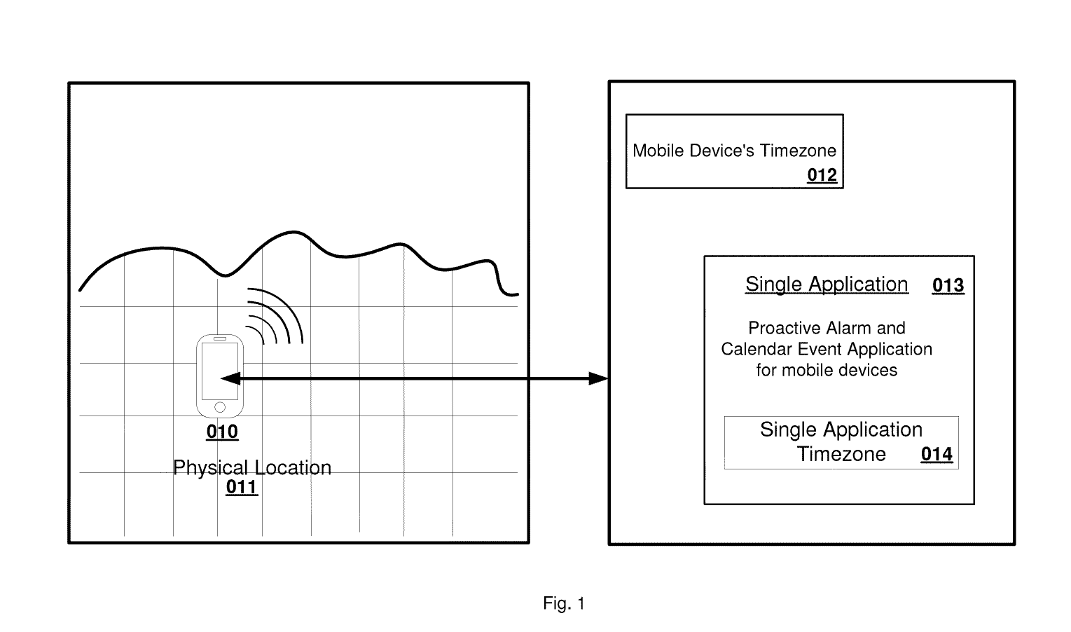

FIG. 1 illustrates an exemplary use of an alarm and calendar event management system for a mobile device according to an embodiment of the present patent application. Referring to FIG. 1, a mobile device 010, currently located at a location address 011 of a physical location (e.g. at a street address, city, province/state, country), is powered on, and with the currently active time zone (012, 014) established for both the mobile device 010 and the alarm and calendar event management system 013 loaded in the mobile device 010.

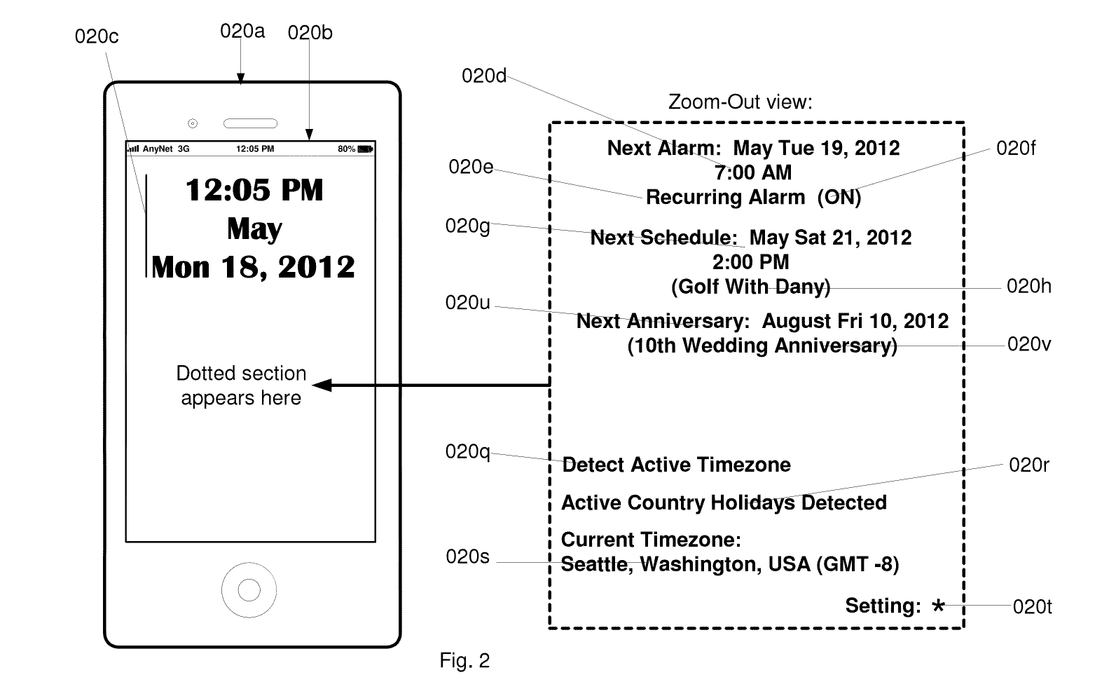

FIG. 2 shows an alarm and calendar event management system for a mobile device 020a with a screen display 020b that displays an illustrative user interface with functions available to a user after the alarm and calendar event management system has started up successfully. Referring to FIG. 2, the user interface displays the mobile device's current date and time 020c, the next alarm's date and time 020d, the type of the next alarm 020e, the next alarm current status 020f, the user's next schedule date and time 020g, the schedule name 020h, the user's next anniversary date 020u, and the anniversary name 020v.

Referring to FIG. 2, the type of the alarm 020e may be a recurring alarm or a personal alarm, although FIG. 2 shows “Recurring Alarm” for illustration purposes. Regarding the alarm status 020f, the user interface currently shows “ON” in FIG. 2 to indicate that the next recurring alarm is currently activated and will fire on the date and time 020d. The status for the next recurring alarm can also include an “OFF” status meaning that the next recurring alarm is currently deactivated (i.e. disabled) and will not fire on the date and time 020d. The same two statuses “ON” and “OFF” also apply to the next personal alarm.

Referring to FIG. 2, the alarm and calendar event management system's main screen interface also displays the alarm and calendar event management system's current time zone information 020s, and whether any active country holidays are detected 020r for the current calendar year. The alarm and calendar event management system's main screen shows the alarm and calendar event management system's current time zone information, i.e. Current Time zone: Seattle, Wash., USA (GMT−8).

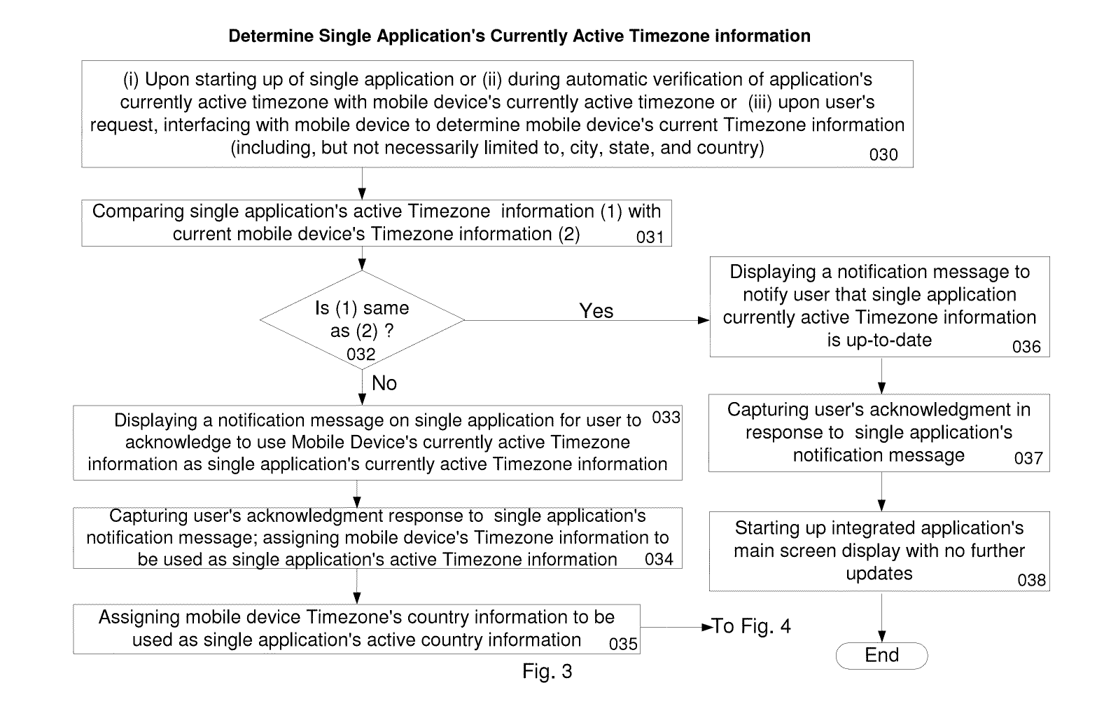

FIG. 3 is a flowchart illustrating an exemplary process of determining a currently active time zone of an alarm and calendar event management system based on a mobile device's currently active time zone, executed on the alarm and calendar event management system, according to another embodiment of the present patent application. Referring to FIG. 3, in step 030, (i) upon starting up of the single application; (ii) during automatic verification of the application's currently active time zone with the mobile device's currently active time zone, or (iii) upon detecting a user's request when the user taps on “Detect Active Time zone” request link 020q on the touch sensitive mobile device display to locate the alarm and calendar event management system's currently active time zone at the physical location address (i.e. 011 from FIG. 1), the alarm and calendar event management system responds by communicating with the mobile device operable to determine the mobile device's current time zone information by comparing the alarm and calendar event management system's active time zone information with the current mobile device's time zone information (step 031).

Referring to FIG. 3, if the alarm and calendar event management system detects that the mobile device's currently active time zone information is the same as the alarm and calendar event management system's currently active time zone information (step 032), the integrated application displays a notification message to notify the user that the alarm and calendar event management system's currently active time zone information is up-to-date (step 036), followed by displaying application's main screen display with the currently existing time zone unchanged as shown in FIG. 2 (steps 037 and 038). If the alarm and calendar event management system detects that the mobile device's currently active time zone information is not the same as the alarm and calendar event management system's currently active time zone information (step 032), the alarm and calendar event management system displays a notification message for the user to acknowledge using the mobile device's currently active time zone information as the alarm and calendar event management system's currently active time zone information (step 033), followed by the user acknowledging the alarm and calendar event management system's notification message, after which the alarm and calendar event management system captures the user's acknowledgment response, followed by the alarm and calendar event management system assigning the mobile device's currently active time zone information to be used as the alarm and calendar event management system's currently active time zone information (step 034) with the alarm and calendar event management system's active country becoming the country that matches the country found inside the device's current time zone (step 035). After that, the alarm and calendar event management system determines if there are active country holidays based on the alarm and calendar event management system's new currently active time zone, which will be described hereafter in more detail.

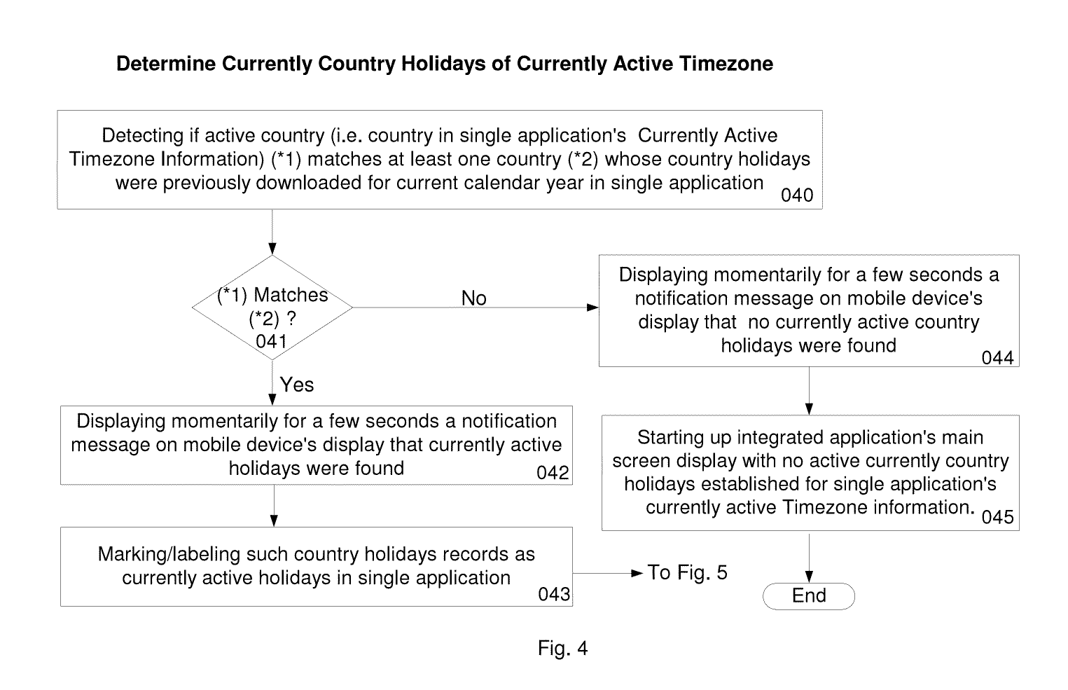

FIG. 4 is a flowchart illustrating an exemplary process of determining currently active country holidays based on the alarm and calendar event management system's currently active time zone, executed on the alarm and calendar event management system. In this process, the alarm and calendar event management system proceeds with finding if there are any country holidays for the currently active time zone and displaying a notification of such process taking place.

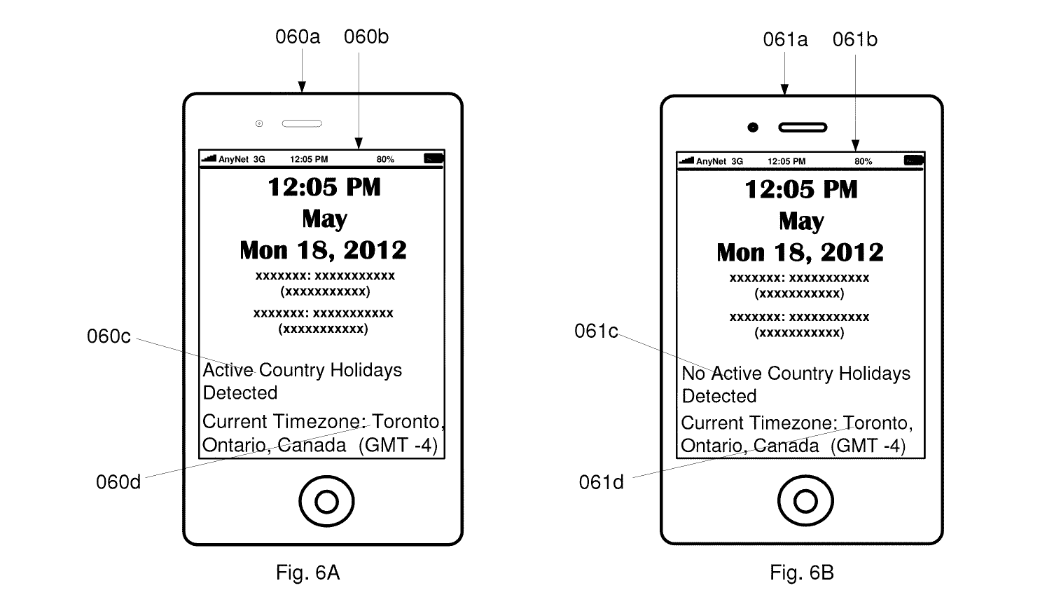

If the alarm and calendar event management system detects that the user has not previously downloaded any country holidays for alarm and calendar event management system's currently active time zone for current calendar year (steps 040 and 041), the alarm and calendar event management system proceeds with displaying an appropriate user interface with an appropriate notification message that no country holidays were detected (for the current calendar year) (step 044), followed by displaying in the application's main screen display with the active time zone newly established (061d in FIG. 6B) and displaying that no country holidays were detected (for the current calendar year) (061c in FIG. 6B) as illustrated by step 045 in FIG. 4.

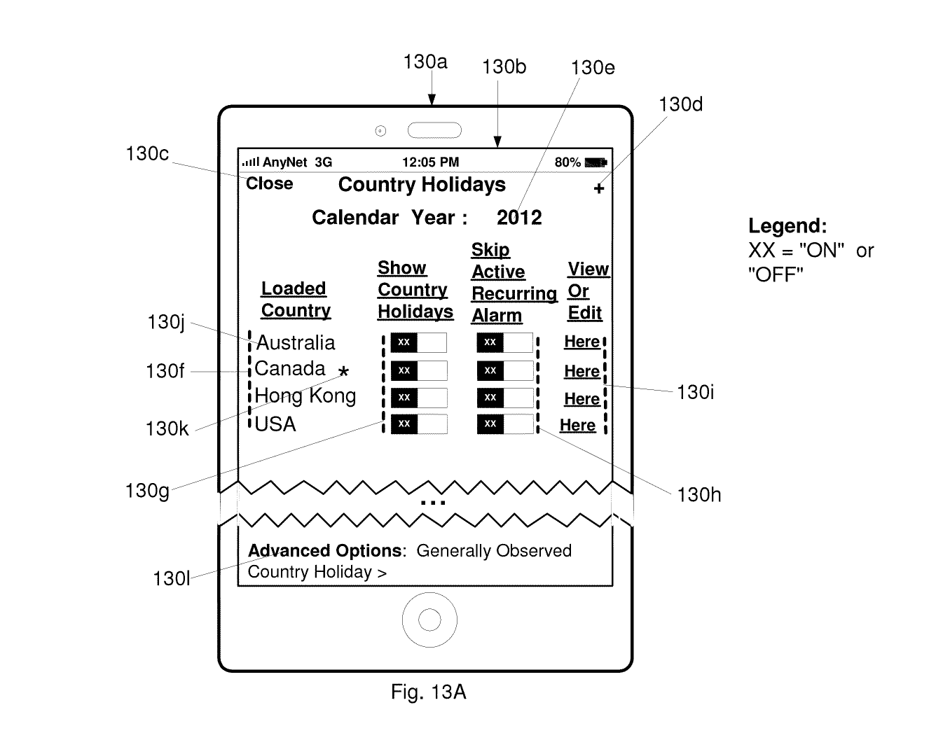

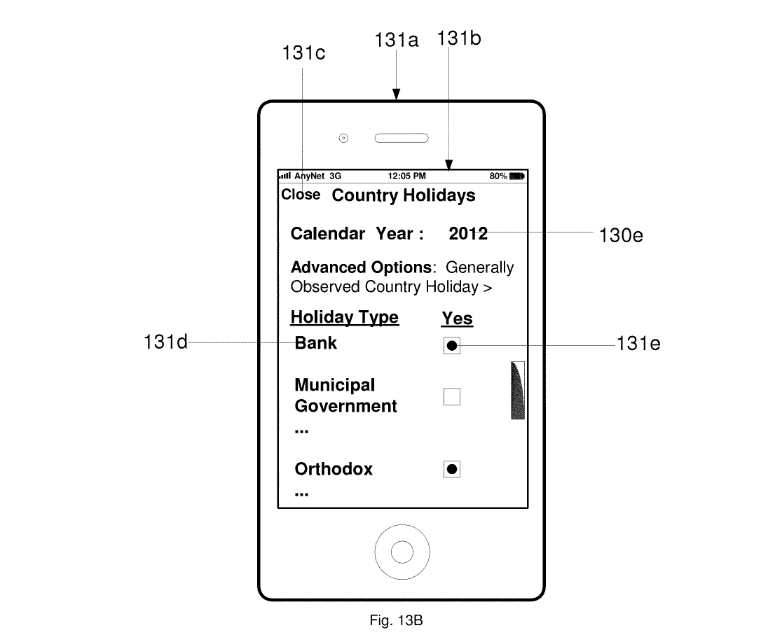

If the alarm and calendar event management system detects that the user has previously downloaded country holidays for the alarm and calendar event management system's currently active time zone and for device's current system's calendar year and such downloaded country holidays' activation feature is enabled (i.e. “Show Country Holidays” feature is activated (i.e. toggle switch 133i reads “ON” in FIG. 13A) (steps 040 and 041), the alarm and calendar event management system proceeds to display an appropriate notification message on the mobile device screen to notify the user that the currently active holidays are found (step 042), and to mark those country holiday records as the currently active country holidays (step 043).

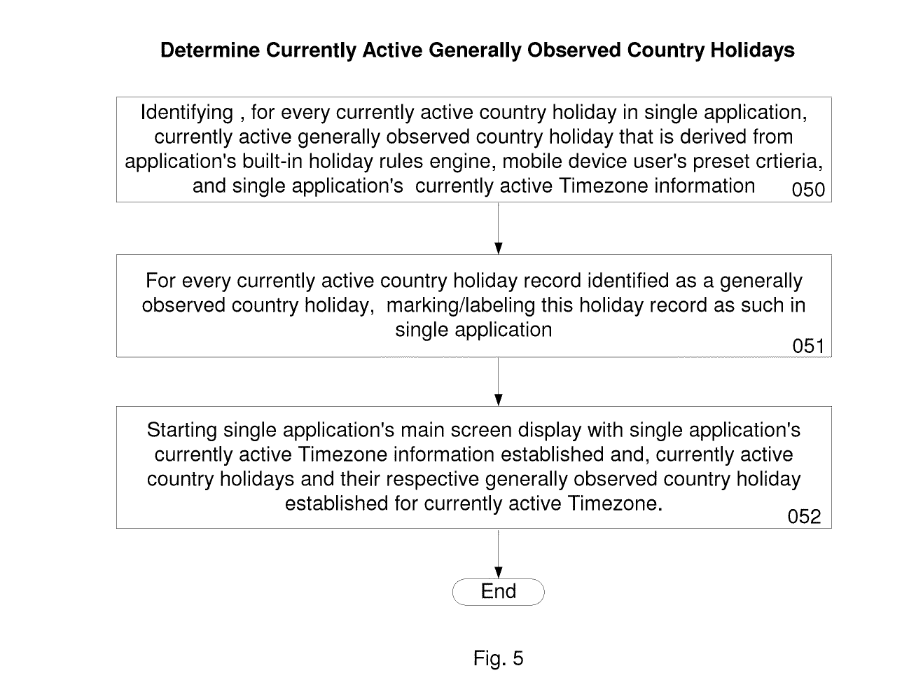

FIG. 5 is a flowchart illustrating an exemplary process of determining currently active generally observed country holidays based on the alarm and calendar event management system's built-in country holidays rule engine, the mobile device user's preset criteria, and the alarm and calendar event management system's currently active time zone, executed on the alarm and calendar event management system. Referring to FIG. 5, the alarm and calendar event management system proceeds with finding associated generally observed country holiday(s) for the marked active country holiday(s) that have been previously identified and displaying an appropriate notification message on device screen display that such process is taking place. Such process shown being executed is applied to every currently active country holidays that have been marked in step 043 (shown in FIG. 4), during which process the alarm and calendar event management system determines whether such currently active holiday is deemed as a currently active generally observed country holiday based on alarm and calendar event management system's built-in holiday rules engine, along with the mobile device user's previous settings as illustrated in FIG. 13B (where applicable), and the alarm and calendar event management system's currently active time zone information (step 050).

In step 051, after the alarm and calendar event management system has the identified impacted country holiday records and marked the impacted country holiday(s) as currently active generally observed country holiday(s), it further displays a notification message signifying the detection of such currently active generally observed country holiday(s) on the mobile device display.

In step 052, the alarm and calendar event management system proceeds with refreshing the alarm and calendar event management system with a main screen display with the active time zone newly established, along with the currently active generally observed country holidays established, and an appropriate message that shows active country holidays are detected (for the current calendar year) (060c in FIG. 6A) along with the new current time zone information (060d in FIG. 6A).

As mentioned above, the alarm and calendar event management system further includes means for determining a subset of the country holidays as generally observed country holidays based on a built-in holiday rules engine, a user's preset criteria, and time zone information of the mobile device. As described in more detail hereafter, the means for selectively disabling the recurring alarms may be configured to disable the recurring alarms on all generally observed country holidays.

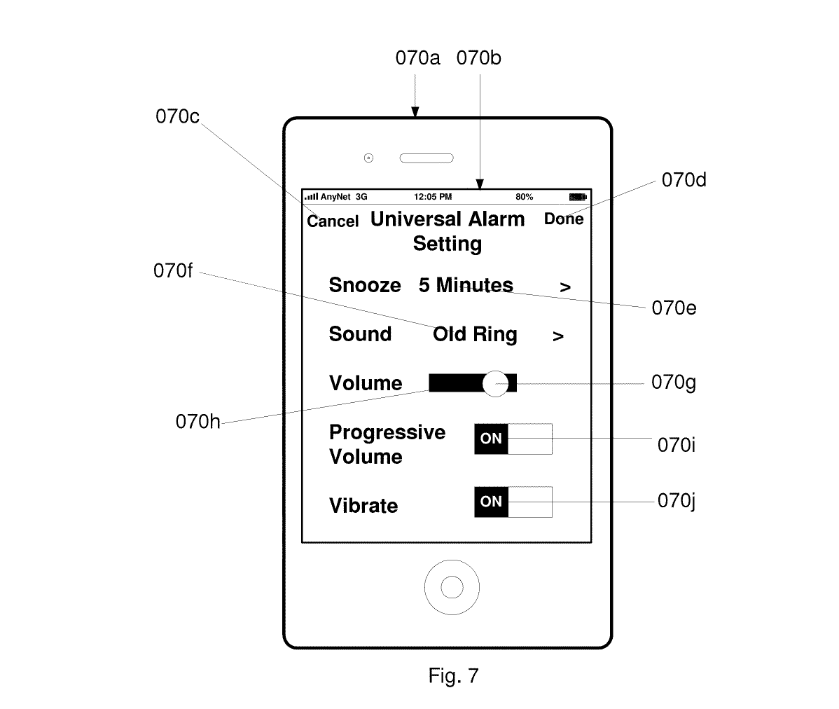

FIG. 7 is a schematic view of an exemplary illustrative user interface through which a user can set up the alarm and calendar event management system's Universal Alarm Setting according to another embodiment of the present patent application. By an initial default, all alarm records being newly created (i.e. being set up) in the alarm and calendar event management system are inheriting the setting parameters captured in individual universal alarm settings (070e-070j) for alarm firing purposes.

In the alarm and calendar event management system's context, any alarm that inherits the alarm and calendar event management system's universal alarm setting parameters for alarm firing purposes is referred to as an inheriting alarm, including recurring alarms and personal alarms. Recurring alarms in the alarm and calendar event management system always inherit the alarm and calendar event management system's universal alarm setting parameters as its parameters for alarm firing purposes, whereas personal alarms have overriding parameters of their own that can bypass the use of the universal alarm setting parameters altogether.

Referring to FIG. 7, a mobile device 070a has a screen display 070b that displays a user interface with functions available for a user to set the following parameters to be used with the associated universal alarm settings being created and/or edited: a snooze parameter (e.g. 5 Minutes) 070e, a sound parameter (e.g. Old Ring) 070f, a volume aspects (setting) of the universal alarm setting (070g, 070i), and a vibrate (parameter) setting 070j.

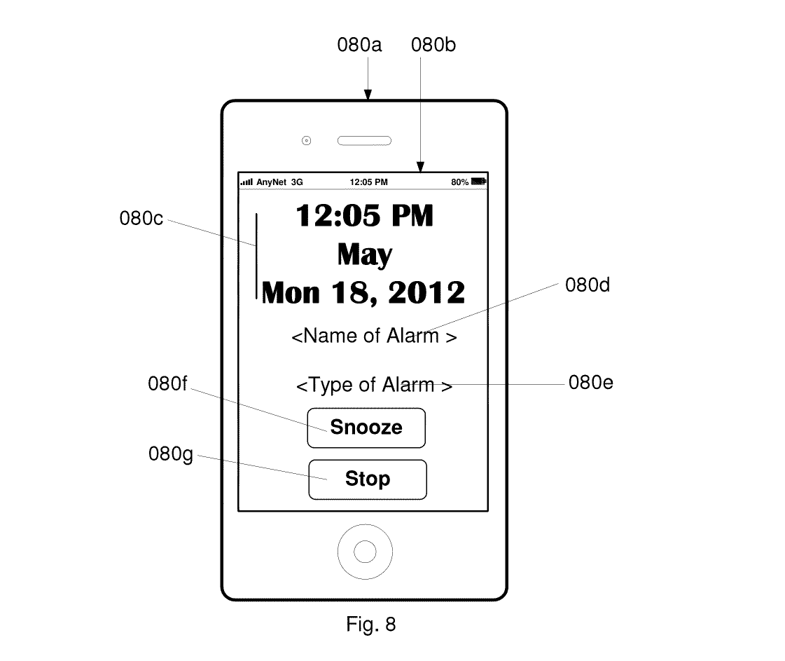

FIG. 8 shows a mobile device 080a with a screen display 080b that displays an illustrative user interface with functions available to the user during the firing execution of a specific type of alarm (e.g. recurring alarm, personal alarm). Referring to FIG. 8, the name of an alarm 080d (where applicable), the type of the alarm 080e (e.g. recurring alarm or personal alarm), a touch sensitive snooze pushbutton 080f, a touch sensitive stop pushbutton 080g, as well as the mobile device's current internal clock, date and time 080c are being displayed on the illustrative user interface.

According to another embodiment of the present patent application, in the alarm and calendar event management system, the means for setting up the recurring alarms are configured to configure the recurring alarms to fire in a plurality of periodical shift cycles, on dates with fixed chronological shifts in each shift cycle, and at different time in a day on the dates in different shift cycles.

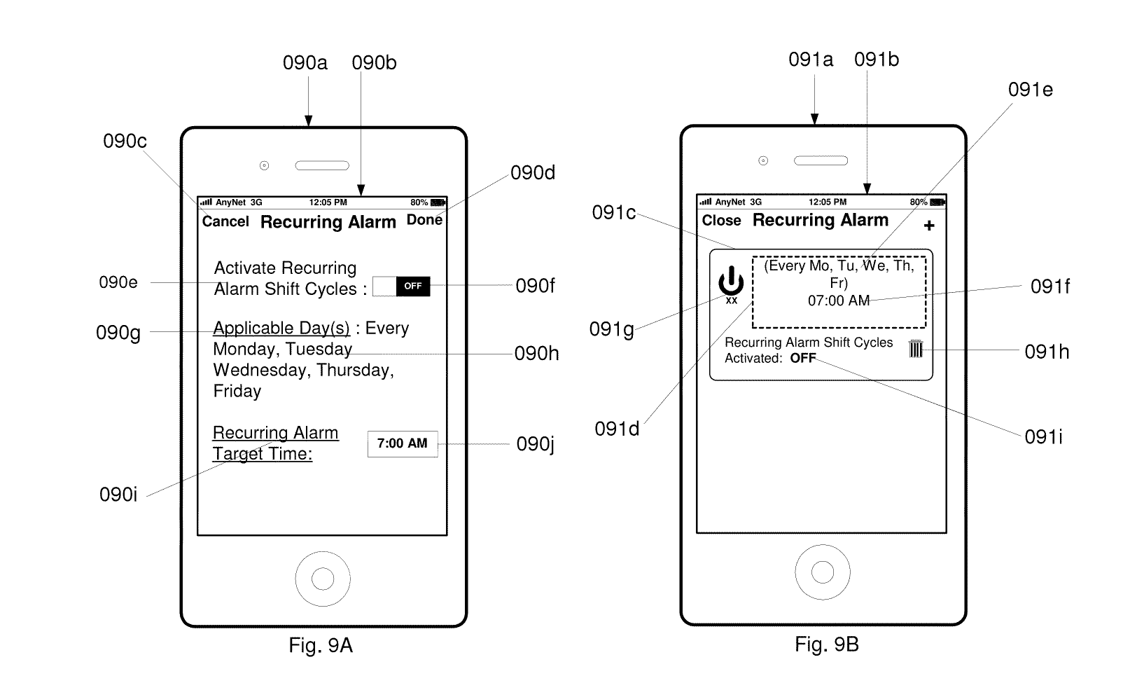

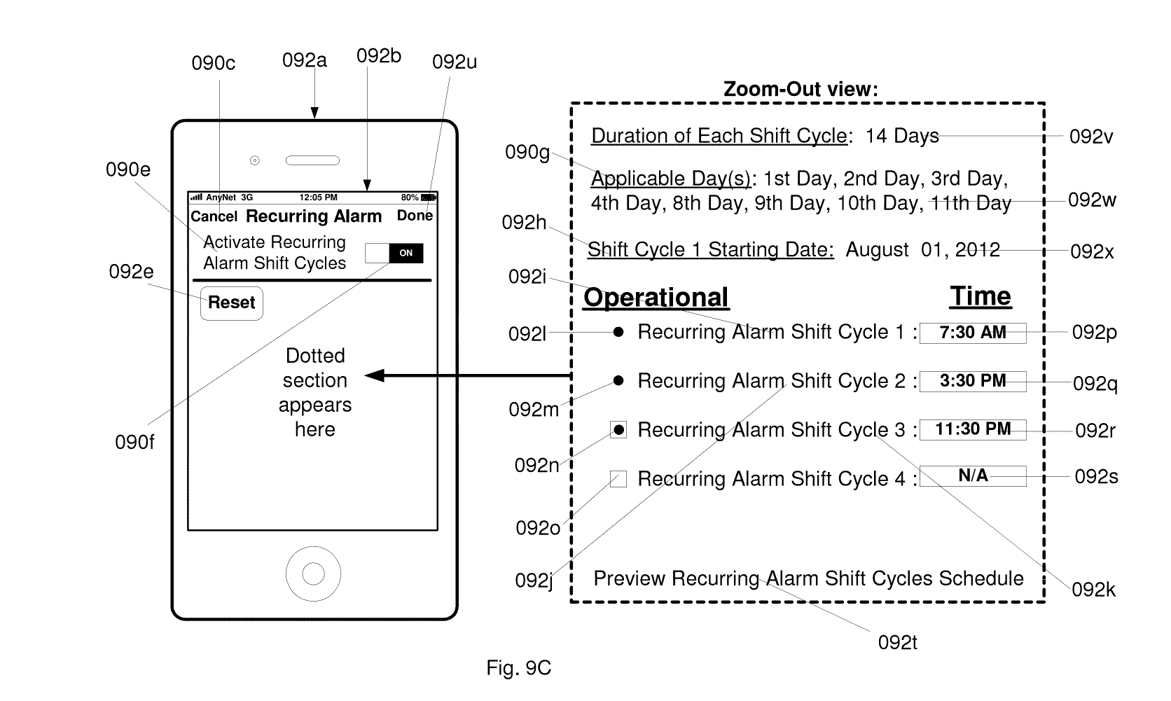

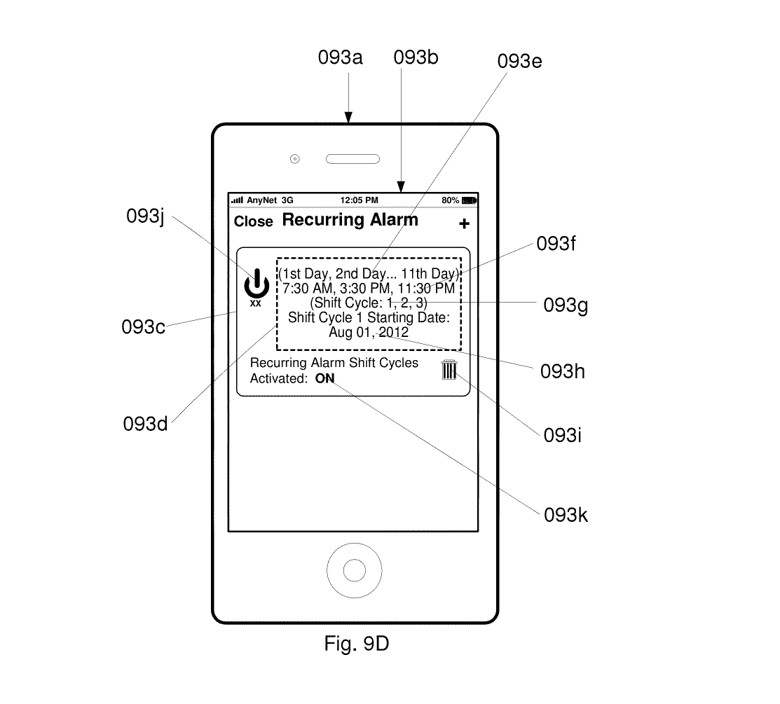

FIG. 9A shows an illustrative user interface with a schematic view of functions available to a user for creating a recurring alarm and/or editing an existing recurring alarm of a non-shift cycle nature according to another embodiment of the present patent application.

FIG. 9B shows an illustrative user interface showing a recurring alarm block that represents an existing non-shift cycle related recurring alarm record according to the embodiment depicted in FIG. 9A.

FIG. 9C shows an illustrative user interface with a schematic view of functions available to a user for creating a recurring alarm and/or editing an existing recurring alarm of a shift cycle nature according to another embodiment of the present patent application.

FIG. 9D shows an illustrative user interface showing a recurring alarm block that represents an existing shift cycle related recurring alarm record according to the embodiment depicted in FIG. 9C.

It is noted that a particular recurring alarm may be triggered by one or more than one trigger source (e.g. a country holiday, a personal holiday, or via a daily event pop-up window while viewing a virtual calendar month display view), thereby be disabled (i.e. skipped). By definition, in the alarm and calendar event management system's context, an active recurring alarm is defined as a recurring alarm that is active or activated and it will fire on appointed calendar days and time every week according to the user's setup in the recurring alarm setting unless the recurring alarm has been disabled for those specific calendar date(s). Moreover, a recurring alarm, irrespective of its status (i.e. active or inactive), can be programmed to be skipped by one or more requesting trigger sources, in which case, the alarm and calendar event management system creates a necessary trigger mechanism for skipping any recurring alarm.

Referring to FIG. 9B and FIG. 9D, in situations where an active recurring alarm has been disabled (i.e. skipped by one or more of the aforementioned trigger sources) for specific dates that do not fall on any of the recurring alarm's associated user selected days (091e, 093e), such active recurring alarm will not fire on those specific dates.

Similarly, referring to FIG. 9B and FIG. 9D, in situations where a recurring alarm is switched off or deactivated (i.e. recurring alarm's toggle switch (091g, 093j) reads “OFF”), such a recurring alarm will not fire on those specific date(s).

Referring to FIG. 9A, the “Applicable Day(s):” feature 090g is a touch sensitive feature of an associated non-shift cycle related recurring alarm that is associated with chosen day(s) (090h) entered by the mobile device user in a weekly calendar day format (e.g. Every Monday, Every Thursday, etc.) as applicable days for the purpose of firing associated recurring alarm.

Referring to FIG. 9C, the “Applicable Day(s):” feature 090g is a touch sensitive feature of an associated shift cycle related recurring alarm that is associated with chosen day(s) (092w) entered by the mobile device user in (i) a weekly calendar day format (e.g. Every Monday, Every Thursday, etc.) or (ii) individual chronological shift day(s) within each shift cycle (e.g. “3rd Day”) to identify such chosen day(s) (092w) as applicable days for the purpose of firing associated recurring alarm.

Still referring to FIG. 9C, it is further implied that a mobile device user has the option to select chosen days (i.e. 092w in FIG. 9C), although not specifically shown in FIG. 9C, for an individual shift cycle (i.e. user's chosen day(s) for a particular shift cycle can be different from another shift cycle's chosen day(s)) or set up the same chosen day(s) for all shift cycles for the purpose of firing recurring alarm(s).

The non-shift cycle related recurring alarm in FIG. 9A is created or edited for situation where the associated recurring alarm's feature “Activate Recurring Alarm Shift Cycles” 090e is deactivated (i.e. toggle switch 090f reads “OFF”). A recurring alarm with its feature, “Activate Recurring Alarm Shift Cycles” 090e, deactivated (i.e. touch sensitive toggle switch 090f reads “OFF”) is defined as a non-shift cycle related recurring alarm, which the alarm and calendar event management system is configured to interpret as a recurring alarm of a non-shift cycle nature prevailing in the alarm and calendar event management system.

To de-activate the “Activate Recurring Alarm Shift Cycles” feature 090e, the mobile device user engages the toggle switch button 090f until the toggle switch button's indicator reads “OFF” on the button 090f, after which the alarm and calendar event management system is configured to interpret the associated recurring alarm linked to the button 090f as a non-shift cycle related recurring alarm, hide all the recurring alarm's shift cycle related components, and disable those components' functionalities altogether for the recurring alarm (i.e. touch sensitive components 092e, 092f, 092h, 092n, 092o, 092p, 092q, 092r, 092t in FIG. 9C will not be visible on the mobile device display).

The illustrative example is shown in FIG. 9A with displayed information on the mobile device 090a′ display 090b, after a user has finished the process of entering and/or editing individual respective parameter values of an associated non-shift cycle related recurring alarm.

The “Activate Recurring Alarm Shift Cycles” feature 090e is deactivated (i.e. toggle switch button 090f reads “OFF”) by the mobile device user. The “Applicable Day(s)” feature 090g associated with individual weekly calendar chosen days: “Every Monday, Tuesday . . . Friday” 090h is selected by the mobile device user. The “Recurring Alarm Target Time:” feature 090i associated with recurring alarm's firing time 090j is entered by the mobile device user.

Following the completion of creating and/or editing activities of current recurring alarm, referring to FIG. 9A, the mobile device user confirms relevant editable information associated with the current recurring alarm by engaging for a single time touch sensitive icon link, “Done” 090d, after which the alarm and calendar event management system responds by (i) validating respective editable relevant information associated to the non-shift cycle related recurring alarm, and after successful validation, (ii) saving associated recurring alarm data, followed by (iii) refreshing the mobile device's screen display with appropriate user interface as shown in FIG. 9B.

FIG. 9B shows a mobile device 091a with a screen display 091b that displays an illustrative user interface, reflecting the most recent parameter information that the mobile device user has most recently confirmed for the associated recurring alarm. A recurring alarm block 091c represents an individual existing recurring alarm, within which the following touch sensitive components can be found: a touch sensitive recurring alarm activation toggle switch 091g for switching ON (i.e. toggle switch 091g reads “ON”) or OFF (i.e. toggle switch 091g reads “OFF”) the associated recurring alarm, a touch sensitive delete request link 091h for the user to delete the associated recurring alarm record, a recurring alarm's shift cycle activation status indicator 091i to identify whether the associated recurring alarm's feature “Activate Recurring Alarm Shift Cycles” 090e is activated or not (i.e. reflecting the current toggle switch parameter setting 090f), and a touch sensitive recurring alarm region content section 091d, that, in turn, further holds the most recently edited information for associated non-shift cycle related recurring alarm. Such information includes an Applicable Day Occurrence (e.g. Every Mo, Tu, We, Th, Fr) 091e that reflects the user's chosen day(s) 090h on chosen weekly calendar day(s) on which to fire the associated recurring alarm, and a Target firing time(s) 091f that reflects the user's entered firing time 090j for the associated recurring alarm.

Referring to FIG. 9B, which further illustrates an example of how the alarm and calendar event management system will respond based on the parameter information (091e, 091f, 091g, 091i, 091h), where a mobile device user has chosen weekly calendar day(s) 091e (e.g. Every Monday, . . . , Every Thursday, etc.) as chosen day(s), for the purpose of firing associated non-shift-cycle recurring alarm, the alarm and calendar event management system responds to those parameter information as follows. For every activated (i.e. indicator of 091g reads “ON”) non-shift cycle related recurring alarm, the alarm and calendar event management system enables a trigger mechanism so that the associated recurring alarm will fire on a particular date, coinciding with the mobile device's current system date, and whose weekly calendar day equivalent (e.g. “Monday”) coincides with any of the mobile device user's selected day(s) 091e (e.g. Every Monday, . . . , Friday) on that particular date, and at a specified time 091f (e.g. 07:00 AM) that is associated with associated recurring alarm.

Referring to FIG. 9B, to start the process of requesting for updating an existing recurring alarm with its shift cycles deactivated (i.e. reads “OFF” 091i), a mobile device user engages for a single time the recurring alarm's touch sensitive content region 091d that is shown on the current user interface (i.e. the calling user interface), after which the alarm and calendar event management system responds by refreshing the mobile device display with an illustrative user interface showing associated editable parameter information details of the recurring alarm, with the newly refreshed user interface (i.e. similar to the one shown in FIG. 9A) reflecting the currently displayed parameter information on the calling user interface similar to the one shown in FIG. 9B. From that newly refreshed user interface, the mobile device user will start the process of updating the recurring alarm's respective editable setting parameters.

FIG. 9C shows a mobile device 107a with a screen display 107b that displays an illustrative user interface with functions available to a mobile device user to enter/edit setting parameters to be associated with a shift cycle related recurring alarm being created or edited for a situation where the associated recurring alarm's feature, “Activate Recurring Alarm Shift Cycles” 090e, is activated (i.e. touch sensitive toggle switch 090f reads “ON”).

A recurring alarm with its feature, “Activate Recurring Alarm Shift Cycles” 090e, activated (i.e. touch sensitive toggle switch button 090f reads “ON”) is defined as a shift cycle related recurring alarm, which the alarm and calendar event management system will interpret as a recurring alarm of a shift cycle nature now prevailing in the alarm and calendar event management system. It is noted that throughout the present patent application, a recurring alarm shift cycle is referred to interchangeably as a shift cycle.

The touch sensitive “Activate Recurring Alarm Shift Cycles” feature 090e is introduced in the alarm and calendar event management system to provide a mobile device user the ability to seamlessly perform a one-time setup of a recurring alarm so that the same active recurring alarm will fire at distinctive target firing time (e.g. 092p, 092q, 092r, 092s in FIG. 9C) depending on which of the recurring alarm's operational recurring alarm shift cycle i (where i=1 to 4 in this embodiment) is active at the recurring alarm firing time. There can only be one operational recurring alarm shift cycle i (where i=1 to 4 in this embodiment) active at any one time.

Referring to FIG. 9C, in order to activate the recurring alarm's “Activate Recurring Alarm Shift Cycles” feature 090e, a mobile device user engages the toggle switch button 090f until the toggle switch button's indicator reads “ON” on the button 090f, after which the alarm and calendar event management system will interpret the associated recurring alarm linked to the button 090f as a shift cycle related recurring alarm, and enables all the recurring alarm's shift cycle related touch sensitive components of that recurring alarm (i.e. touch sensitive components 092e, 092f, 092h, 092n, 092o, 092p, 092q, 092r, and 092t visible on the mobile device's display will respond accordingly when engaged by the mobile device user).

A recurring alarm of a shift cycle nature (i.e. associated “Activate Recurring Alarm Shift Cycles” feature 090e activated (i.e. activation toggle switch 090f reads “ON”)), always has its first two associated shift cycles, “Recurring Alarm Shift Cycle 1” and “Recurring Alarm Shift Cycle 2”, operational as shown in FIG. 9C. Other recurring alarm shift cycles are optional (“Recurring Alarm Shift Cycle M” where M=3 to 4 in this embodiment).

In FIG. 9C, for the sake of simplicity, a shift cycle related recurring alarm has been shown to have only up to four recurring alarm shift cycles when the “Activate Recurring Alarm Shift Cycles” feature 090e is activated (i.e. toggle switch 090f is “ON”). However, for the added flexibility to a mobile device user, in alternative embodiments, a recurring alarm can contain more than four recurring alarm shift cycles when the “Activate Recurring Alarm Shift Cycles” feature 090e is activated (i.e. toggle switch 090f is “ON”).

The recurring alarm's associated touch sensitive feature, “Duration of Each Shift Cycle” 092f, is a feature of the alarm and calendar event management system that allows a mobile device user to enter a duration period 092v (i.e. days, weeks, etc.) to allow the alarm and calendar event management system to identify the duration of each individual operational shift cycle that is associated to the recurring alarm. Such a duration period plays an important role in identifying how long a particular operational shift cycle will remain active before relinquishing its “active” status to a subsequent operational shift cycle, which will be described hereafter in more detail.

The “Duration of Each Shift Cycle” feature 092f associated with a recurring alarm must contain a timeframe duration 092v (e.g. 14 Days, 3 Weeks). The “Shift Cycle 1 Starting Date” feature 092h is a touch sensitive feature of the alarm and calendar event management system that allows a user to enter a required calendar date (e.g. 092×) that the alarm and calendar event management system will interpret as the date on which the first operational shift cycle, “Recurring Alarm Shift Cycle 1” 092i becomes active for the very first time.

Referring to FIG. 9C, a mobile device user can render a specific recurring alarm shift cycle, (e.g. “Recurring Alarm Shift Cycle 3” 092k) operational by engaging a touch sensitive box adjacent to it until an appropriate discernible visual marker 092n (e.g. visually represented by a black color circle appearing inside the box) appears on the mobile device display. With such a visual marker 092n being displayed on the mobile device, the alarm and calendar event management system will interpret a recurring alarm shift cycle (e.g. “Recurring Alarm Shift Cycle 3” 092k) adjacent to such visual marker 092n as an operational recurring alarm shift cycle.

Similarly, while the visual marker 092n is being displayed on the mobile device, and with a mobile device user engaging for a single time the touch sensitive box adjacent to it until such discernible visual marker 092n disappears from the mobile device display, the alarm and calendar event management system will interpret the adjacent recurring alarm shift cycle as a non-operational recurring alarm shift cycle.

When an operational recurring alarm shift cycle is active depends on: (i) the date 092x on which the first operational recurring alarm shift cycle, “Recurring Alarm Shift Cycle 1” 092i becomes active for the first time; (ii) the number of current operational recurring alarm shift cycles; and (iii) the duration period 092v (e.g. 14 Days) entered by the mobile device user.

With the illustration of FIG. 9C, the logic with which the alarm and calendar event management system determines when an individual operational recurring alarm is active is described in more detail hereafter.

The first operational recurring shift cycle of the alarm and calendar event management system “Shift Cycle 1” 092i becomes active for the very first time on Aug. 1, 2012 092x (i.e. date entered for “Recurring Alarm Cycle 1 Starting Date” feature 090e), and remains active for a duration of 14 days 092v (i.e. duration period entered for “Duration of Each Shift Cycle” feature 090e) from Aug. 1, 2012 to Aug. 14, 2012, and relinquishes its active status to a subsequent operational recurring alarm shift cycle that is next on the active progression line (i.e. “Recurring Alarm Shift Cycle 2” 092j), starting on Aug. 15, 2012.

The duration period 092v (e.g. 14 days) entered by the mobile device user for recurring alarm's associated feature, “Duration of Each Shift Cycle” 092f, allows the alarm and calendar event management system to identify the duration period of an individual operational recurring alarm shift cycle. The “Recurring Alarm Shift Cycle p” remains active before relinquishing its active status to another operational recurring alarm shift cycle, “Recurring Alarm Shift Cycle p+1” that is next in line and so on (where 1<=p=<m, and m=number of operational recurring alarm shift cycles; in the embodiment of FIG. 9C, m=3). Furthermore, when p=m, the operational recurring alarm shift cycle p will remain active for the duration period 092v (e.g. 14 Days) held by the “Duration of Each Shift Cycle” feature 092f before relinquishing its “active” status back (i.e. in a looping fashion) to the recurring alarm's first operational shift cycle, “Recurring Alarm Shift Cycle 1” 092i, and the process of the above-mentioned relinquishing the “active” status continues on indefinitely.

To activate the “Activate Recurring Alarm Shift Cycles” feature 090e, the mobile device user engages the toggle switch button 090f until the toggle switch button's indicator reads “ON” on the button 090f, after which the alarm and calendar event management system will interpret the associated recurring alarm linked to the button 090f as a shift cycle related recurring alarm, and enable all the recurring alarm's shift cycle related touch sensitive components of that recurring alarm (i.e. touch sensitive components 092e, 092f, 092h, 092n, 092o, 092p, 092q, 092r, and 092t, visible underneath mobile device, will respond accordingly when engaged by the mobile device user).

To enter a duration time 092v for “Duration of Each Shift Cycle” feature 092f, the mobile device user engages for a single time touch sensitive toggle switch button 092f, after which the alarm and calendar event management system refreshes the mobile device display with an appropriate user interface with functions available to the user for entering the duration time 092v and awaiting user's actions.

After that, the mobile device user enters a duration period (e.g. 14 Days) 092v, and saves the entered data through an appropriate action that is understood by the alarm and calendar event management system, after which the alarm and calendar event management system captures the entered duration period, and refreshes the mobile device display back with the calling user interface (as shown in FIG. 9C) with the newly entered duration period 092v being reflected on the calling illustrative user interface.

The mobile device user then enters the chosen day(s) 092w to be associated with the “Applicable Day(s):” feature 090g by engaging for a single time touch sensitive text link, “Applicable Day(s):” 090g, after which the alarm and calendar event management system refreshes the mobile device display with an appropriate user interface with functions available to the user for entering chosen day(s) 092w and awaiting user's actions.

The mobile device user selects appropriate day(s) 092w (e.g. “1st Day, 2nd Day, 3rd Day, 4th Day, 8th Day, 9th Day, 10th Day, 11th Day”) from a list of selections on the mobile device, and saves the selected data through an appropriate action that is understood by the alarm and calendar event management system, after which the alarm and calendar event management system captures the chosen day(s) 092w that the mobile device user has selected, and refreshes the mobile device display back with the calling user interface (i.e. as shown in FIG. 9C) with the newly entered chosen day(s) 092w being reflected on the calling illustrative user interface.

The mobile device user can render a specific recurring alarm shift cycle, (e.g. “Recurring Alarm Shift Cycle 3” 092k) operational by engaging an adjacent touch sensitive box until a discernible visual marker 092n (e.g. shown as a black color circle) appears inside the box. With the visual marker present on the box, the alarm and calendar event management system will interpret the adjacent recurring alarm shift cycle (e.g. Recurring Alarm Shift Cycle 3”) as operational.

For every individual recurring alarm shift cycle that has been rendered operational (e.g. “Recurring Alarm Shift Cycle 3” 092k), the mobile device user starts the process of entering a firing time to be associated with that operational recurring alarm shift cycle by engaging for a single time respective touch sensitive time entry box adjacent to the operational recurring alarm shift cycle (e.g. “Recurring Alarm Shift Cycle 3” 092k), followed by entering the associated recurring alarm firing time (e.g. 092r) inside the box, after which the alarm and calendar event management system will interpret such firing time (e.g. 092r) to be associated with the adjacent operational recurring alarm shift cycle (e.g. “Recurring Alarm Shift Cycle 3” 092k).

A mobile device user then enters a date by engaging for a single time respective touch sensitive “Shift Cycle 1 Starting Date:” feature text link 092h, after which the alarm and calendar event management system refreshes the mobile device display with an appropriate user interface with functions available to the user for entering the date 092x and awaiting user's actions.

After that, the mobile device user enters the date (e.g. Aug. 1, 2012) 092x, and saves the entered date through an appropriate action that is understood by the alarm and calendar event management system, after which the alarm and calendar event management system captures the entered date 092x, and refreshes the mobile device display back with the calling user interface (shown in FIG. 9C) with the newly entered date 092x being reflected on the calling illustrative user interface.

Referring to FIG. 9C, the displayed information on the mobile device 092a's display 092b after a user has finished the process of entering and/or editing individual respective parameter values of an associated recurring alarm includes: an “Activate Recurring Alarm Shift Cycles” feature 090e activated (i.e. toggle switch button 090f reads “ON”) by the mobile device user; a “Duration of Each Shift Cycle” feature 092f with a duration period of 14 Days 092v that is entered by the mobile device user; an “Applicable Day(s):” feature 090g associated with the mobile device user's individual chosen days: “1st Day, 2nd Day, 3rd Day, 4th Day, 8th Day, 9th Day, 10th Day, 11th Day” 092w of every shift cycle; three operational recurring alarm shift cycles (identified through appropriate visual markers: 092l, 092m, 092n) for respective adjacent operational recurring alarm's shift cycles (092i, 092j, 092k), including the additional recurring alarm shift cycle (e.g. 092k) identified by the mobile device user as operational and to be associated with the recurring alarm being created or edited; the recurring alarm's firing time (092p, 092q, 092r) that is entered by the mobile device user to be associated to the adjacent operational recurring alarm's shift cycles (092i, 092j, 092k) respectively; and the Starting Date 092x (e.g. Aug. 1, 2012) that is chosen by the mobile device user and to be associated with the adjacent “Shift Cycle 1 Starting Date” feature 092h.

After that, referring to FIG. 9C, the mobile device user confirms relevant editable information associated to its respective recurring alarm by engaging for a single time the touch sensitive icon link, “Done” 092u, after which the alarm and calendar event management system responds by (i) validating respective editable relevant information associated to the recurring alarm, and after successful validation, (ii) saving relevant recurring alarm data, followed by (iii) refreshing mobile device's screen display with an appropriate user interface as shown in FIG. 9D.

FIG. 9D shows a mobile device 093a with a screen display 093b that displays an illustrative user interface, reflecting the most recently updated parameter information that the mobile device user has most recently confirmed for the associated recurring alarm, with the following displayed representation: a recurring alarm block 093c, representing an individual existing recurring alarm whose parameter information reflects the most recently confirmed parameter information, within which can be found the following touch sensitive components: a touch sensitive recurring alarm activation toggle switch 093j for switching ON (i.e. toggle switch 091g reads “ON”) or OFF (i.e. toggle switch 093j reads “OFF”) the associated recurring alarm; a touch sensitive delete request link 093i for requesting for the deletion of associated recurring alarm record; a recurring alarm shift cycle activation status indicator 093k for identifying whether associated recurring alarm's “Activate Recurring Alarm Shift Cycles” feature 090e is activated or not (i.e. reflecting the current toggle switch parameter setting 090f); a touch sensitive recurring alarm region content section 093d that, in turn, further holds the most recently edited information for the associated shift cycle related recurring alarm, which includes: User's Selected Day(s) (e.g. “1st Day, 2nd Day, 3rd Day, 4th Day, 8th Day, 9th Day, 10th Day, 11th Day” OR Every Monday to Friday) 093e that reflects the mobile device user's chosen day(s) 092w on which to fire the associated recurring alarm; Target firing time(s) 093f that reflects user's entered time [092p, 092q, 092r] for individual operational shift cycles [092i, 092j, 092k] respectively; Applicable operational shift cycle(s) indicator 093g that reflects the user's chosen shift cycles [092i, 092j, 092k] deemed as operational (i.e. reflecting individual visual marker [0921, 092m, 092n] for each of the shift cycle [092i, 092j, 092k] respectively; Shift Cycle 1 Starting Date 093h showing the date on which the first operational shift cycle “Recurring Alarm Shift Cycle 1” of the associated recurring alarm will first become active, the date reflecting the user's previously entered date 092x; and Current recurring alarm's shift cycle activation status 093k to identify whether the associated recurring alarm's feature “Activate Recurring Alarm Shift Cycles” 090e is activated (i.e. reflecting current toggle switch parameter setting 090f).

Referring to FIG. 9D, which illustrates with an example on how the alarm and calendar event management system will respond based on the parameter information (093e, 093f, 093g, 093h, 093k, 093j) and where the mobile device user has chosen specific chronological shift cycle day(s) 093e (e.g. 1st Day, 2nd Day . . . etc.) for the purpose of firing associated activated recurring alarm, the alarm and calendar event management system will respond to those parameter information as follows.

For every activated recurring alarm (i.e. indicator 093j reads “ON”), the alarm and calendar event management system will enable a trigger mechanism so that the recurring alarm will fire on a particular date coinciding with the mobile device's current system date, and whose chronological shift cycle day equivalent (e.g. “2nd day” of each shift cycle) coincides with the mobile device user's selected day 093e (e.g. 2nd Day) of the respective operational shift cycle that is currently prevailing (i.e. active) on that particular date, and at a specified time 093f (e.g. 3:30 PM) that is associated with respective operational shift cycle 093g (e.g. Shift Cycle 2) that is currently prevailing (i.e. active) on such particular date.

The chronological shift cycle day equivalent of a particular date associated for a given prevailing active operational shift cycle is determined on the following basis. Alarm and calendar event management system always initializes when the chronological shift cycle day equivalent with a value of the “1st Day” for the date (i.e. Aug. 1, 2012 in our illustrative example) of the Operational Shift Cycle 1 first become active, and when the chronological shift cycle day equivalent's clock starts ticking. Subsequently, the alarm and calendar event management system also always initializes a value of “1st Day” as chronological shift cycle day equivalent to a particular date that falls on the first day that any given operational shift cycle becomes active. For each date of any given shift cycle, the alarm and calendar event management system associates to its chronological shift cycle day equivalent well in advance of that date coinciding with current mobile device's system date. On any given date whose chronological shift cycle day equivalent is the “dth Day”, within a currently active operational shift cycle that is prevailing (i.e. active), while assuming the duration period of each shift cycle is known to be a duration of “y” days, the alarm and calendar event management system will increase chronological shift cycle day equivalent's count by one day increment (e.g. from the “dth Day” to “d+1 th Day”, where 1<=d<=y) for the following date and this incrementing process continues until the last date of the currently active operational shift cycle when its chronological shift cycle day's count (i.e. yth day) will coincide with the day equivalent value held in “Duration of Each Shift Cycle”. For example, a one week duration period will be equivalent to a 7 day duration period, while the alarm and calendar event management system always assumes a 1 week period consists of 7 days.

Similarly, referring to FIG. 9D, which further illustrates another example of how the alarm and calendar event management system responds on the parameter information (093e, 093f, 093g, 093h, 093k, 093j) where, if a mobile device user has chosen weekly calendar day(s) 093e (e.g. Every Monday, . . . , Every Thursday, etc.) instead of chronological shift cycle day(s) as chosen day(s), for the purpose of firing associated active recurring alarm, the alarm and calendar event management system will respond to the parameter information as follows.

For every activated recurring alarm (i.e. indicator 093j reads “ON”), the alarm and calendar event management system will enable a trigger mechanism so that the recurring alarm will fire on a particular date coinciding with the mobile device's current system date, and whose weekly calendar day equivalent (e.g. “Monday”) coincides with any of the mobile device user's selected day(s) 093e (e.g. every Monday, . . . , Friday) of a respective operational shift cycle that is currently prevailing (i.e. active) on that particular date, and at a specified time 093f (e.g. 3:30 PM) that is associated with respective operational shift cycle that is currently prevailing (i.e. active) on that particular date.

Referring to FIG. 9D, to start the process of requesting for updating an existing shift cycle related recurring alarm, the mobile device user engages for a single time the recurring alarm's touch sensitive content region 093d that is shown on the user interface (i.e. calling user interface), after which the alarm and calendar event management system responds by refreshing the mobile device display with an illustrative user interface similar to the one shown in FIG. 9C showing associated editable parameter information details of the recurring alarm. However with the newly refreshed user interface (i.e. similar to the one as shown in FIG. 9C) reflecting the currently displayed parameter information shown on the calling user interface (similar to the one shown in FIG. 9D), and from the newly refreshed user interface device (similar to the one shown in FIG. 9C) the user will start the process of updating the recurring respective alarm's setting parameters.

Referring to FIG. 9B and FIG. 9D, when the recurring alarm is activated or switched on (e.g. when a user engages touch sensitive activation toggle switch (091g, 093j) until its indicator reads “ON”), the alarm and calendar event management system will respond by enabling a trigger mechanism so that the recurring alarm will be programmed to fire based on its associated parameter information that has been previously entered by the mobile device user.

Referring to FIG. 9B and FIG. 9D, when the recurring alarm is deactivated or switched off (e.g. when a user engages touch sensitive activation toggle switch (091g, 093j) until its indicator reads “OFF”), the alarm and calendar event management system will respond by (i) taking appropriate actions so that the associated recurring alarm is disabled and will not fire and (ii) ignoring and not responding to skipping alarm trigger request(s) for skipping associated alarms.

Moreover, if a recurring alarm record is deactivated, previously or currently active pending request(s) to skip (i.e. disable) the recurring alarm will still be valid for those calendar dates that hold those pending skip request(s) but unapplied to a recurring alarm as there will be no existing active recurring alarm. Subsequently, if the user re-activates an existing recurring alarm, any currently pending skip recurring alarm request(s) will be automatically reapplied by the alarm and calendar event management system to the reactivated recurring alarm accordingly.

Referring to FIG. 9C, the alarm and calendar event management system provides the user with a reset function to change the current recurring alarm's shift cycle schedule through a touch sensitive “Reset” pushbutton 092e. For instance, to replace the current recurring alarm shift schedule (e.g. from a 2-shift cycles) with a new one (e.g. to one with a 4-shift cycles), the mobile device user engages for a single time the touch sensitive “Reset” pushbutton 092e, after which the alarm and calendar event management system responds by displaying an appropriate notification message for user to confirm the reset operation. If the user confirms to proceed with the reset operation, the alarm and calendar event management system responds by performing the following actions: (i) awaiting the user to reenter/reselect respective setting parameters values (092v, 092w, 092x, 092n, 092o, 092p, 092q, 092r, 092s); (ii) capturing the user's entries that are understood by the alarm and calendar event management system; (iii) updating the existing associated recurring alarm with the newly entered/edited parameters and with the newly updated shift cycles schedule being established; (iv) reapplying existing skipping active recurring alarm trigger request(s), if any, to the newly reset associated recurring alarm; and (v) refreshing the mobile device display with the newly reset parameter values (092v, 092w, 092x, 092n, 092o, 092p, 092q, 092r, 092s) being reflected.

During the process of reapplying the existing skip active recurring alarm trigger requests as mentioned in (iv) above, for every specific impacted date, that alarm and calendar event management system detects as having at least a currently active skipping recurring alarm request, the alarm and calendar event management system further determines if such a date is a candidate for firing an active recurring alarm (based on the recurring alarm's newly resetting outcome) in which case the alarm and calendar event management system reapplies the skip active recurring alarm trigger mechanism to the associated recurring alarm so that the active recurring alarm is to be skipped for the impacted date.

If a user engages for a single time the touch sensitive “Cancel” text link 090c, the alarm and calendar event management system responds by proceeding to cancel the current creating or editing activities of the associated recurring alarm record, followed by refreshing mobile device display with the calling user illustrative interface (i.e. the user interface displayed prior to the current user interface).

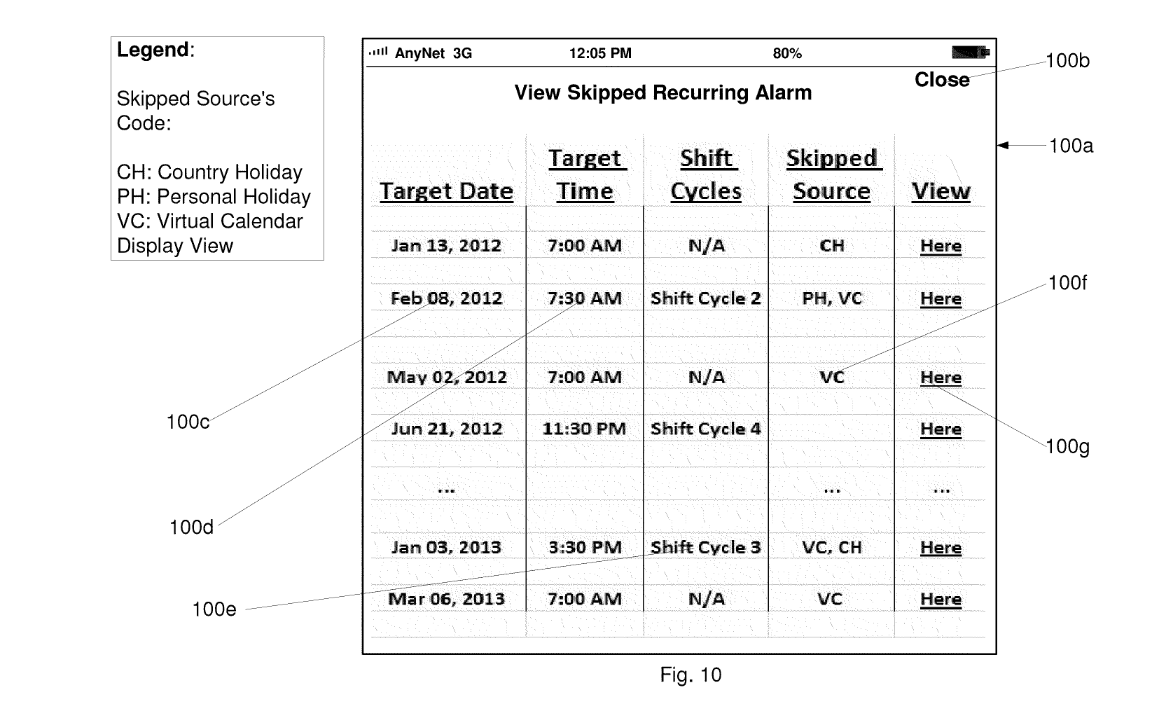

FIG. 10 shows an illustrative screen display 100a on a mobile device that displays an illustrative user interface with functions available to the user to request while displaying a listing of existing skipped (i.e. disabled) recurring alarms (including recurring alarms currently deactivated) for a specific calendar date 100c. Information for each individual associated skipped recurring alarm being listed include: a calendar date 100c, a target time 100d, a shift cycle 100e, a skipped source 100f, and a touch sensitive virtual calendar month view request link 100g.

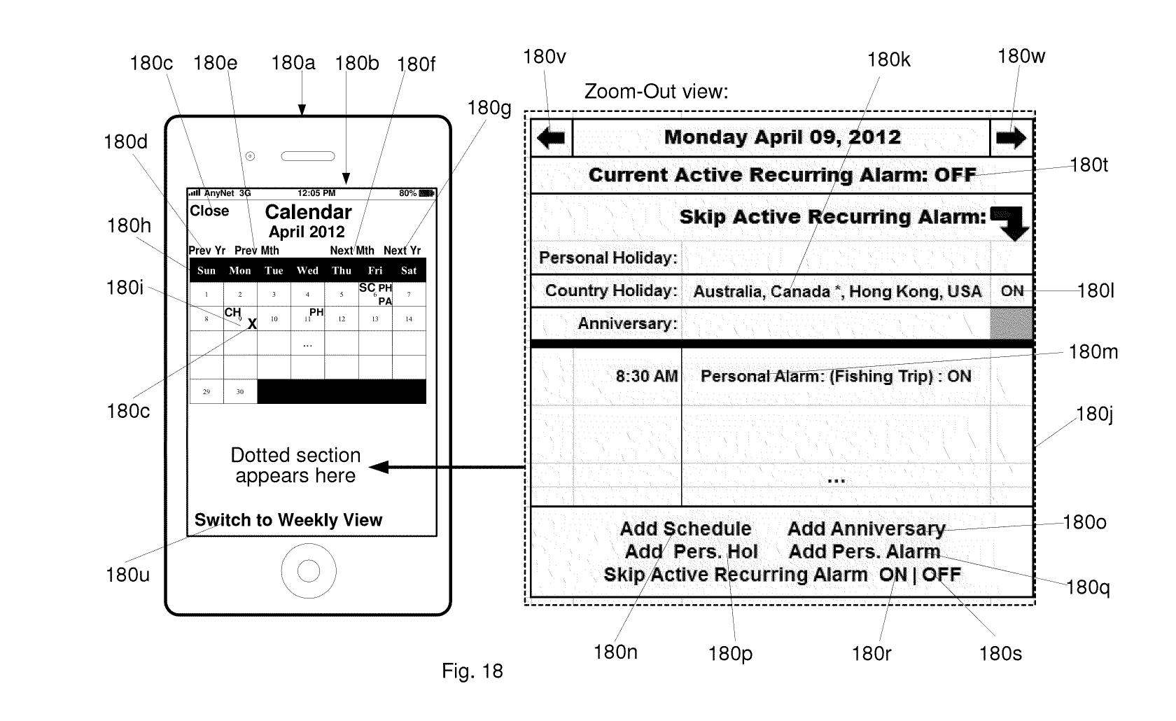

Referring to FIG. 10, if the mobile device user engages for a single time an individual touch sensitive virtual calendar month view request link 100g, the alarm and calendar event management system responds by refreshing the mobile device display with an illustrative user interface similar to the one shown in FIG. 18.

Referring to FIG. 10, an individual source 100f (represented by appropriate markers, shown as CH, PH, and VC for illustration purposes in the illustrative user interface shown in FIG. 10 to represent country holiday, personal holiday, and virtual calendar month respectively) shows the respective trigger source that triggers the skipped recurring alarm to be skipped for the adjacent calendar date 100c.

If a recurring alarm record is deleted by the user (i.e. via touch sensitive links 091h, 093i) from the alarm and calendar event management system or if a recurring alarm is deactivated, any previous currently request(s) to skip specific recurring alarm(s) for specific impacted dates will still be valid for those dates but unapplied to any recurring alarm as there will be no existing recurring alarm.

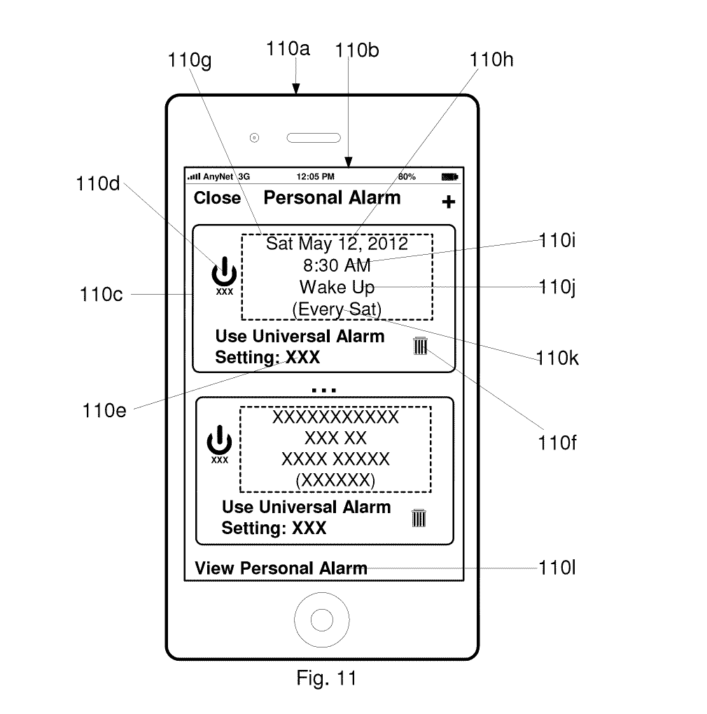

FIG. 11 shows a mobile device 110a with a screen display 110b that displays an illustrative user interface to display a personal alarm, with each block representing an individual existing personal alarm that may or may not have inherited its settings from the alarm and calendar event management system's Universal Alarm Setting (indicator 110e status reading “ON” and “OFF” respectively). Inside each individual personal alarm block 110c being displayed, the following components associated with a personal alarm can be found: a personal alarm touch sensitive activation toggle switch 110d, a delete request link 110f, a Universal Alarm Setting indicator 110e, a touch sensitive personal alarm region content section 110g, that in turn, holds the following information for each individual personal alarm record: target date 110h, target firing time 110i, personal alarm name 110j, and weekly day repeat frequency information 110k.

Referring to FIG. 11, a mobile device user can further activate and de-activate an associated personal alarm by engaging for a single time touch sensitive personal alarm activation toggle switch 110d to set to “ON” and “OFF” to respectively.

Referring to FIG. 11, when a personal alarm is activated (i.e. associated personal alarm activation toggle switch 110d is set to “ON”), the alarm and calendar event management system will fire personal alarm on selected weekly day(s) (if any) on a weekly repeating basis at target date 110h and time 110i. On the other hand, when a personal alarm is deactivated (i.e. associated personal alarm activation toggle switch 110d is set to “OFF”), the alarm and calendar event management system will not fire the personal alarm at all.

The following are the terms that explain relationships relating to country holidays in the context of the alarm and calendar event management system. An active country is one that matches the country (e.g. Canada) found in the alarm and calendar event management system's currently active time zone. A currently active country is one that matches the country (e.g. Canada) found in the alarm and calendar event management system's currently active time zone and country holiday(s) as such country has been downloaded in the alarm and calendar event management system for the mobile device system's current calendar year. A country holiday is currently active when its associated country is a currently active country. A Generally Observed Country Holiday is a holiday of a specific calendar year that is determined based on the alarm and calendar event management system's holiday rules engine, and any preset criteria that may have been created by the mobile device user in the alarm and calendar event management system. An Active Generally Observed Country Holiday is a Generally Observed Holiday in an active country. A Currently Active Generally Observed Country Holiday is a Generally Observed Holiday in a currently active country.

FIG. 13A shows a mobile device 130a with a screen display 130b that displays an illustrative user interface with functions to allow a mobile device user to download country holidays for a specific country and a calendar year, as well as to edit country holidays related information. Furthermore, the illustration in FIG. 13A depicts a situation where country holidays have just been downloaded for a newly reflected country 130j (i.e. Australia) after the downloaded country holidays have been confirmed for a target calendar year 130e by the mobile device user.

In addition, FIG. 13A illustrates a user interface displaying a currently active country “Canada” (i.e. country that matches alarm and calendar event management system's time zone's active country) being displayed with a discernible marker 130k (here shown with an asterisk “*” to identify that country as being the currently active country). Currently active generally observed country holidays for associated calendar year 130e are only applicable to a currently active country as any one time.

The following relevant information is also shown in FIG. 13A: a list of existing countries 130f whose country holidays have previously been downloaded into the alarm and calendar event management system for the target calendar year 130e that the user has previously selected; a touch sensitive toggle pushbutton buttons 130g for enabling associated “Show Country Holidays” feature of adjacent country 130f; touch sensitive toggle pushbuttons 130h for enabling and disabling “Skip Active Recurring Alarm” feature for downloaded country holidays of target calendar year 130e of adjacent country's 130f, a touch sensitive country holiday links 130i for viewing and editing downloaded country holidays of individual adjacent country 130f.

Referring to FIG. 13A, a user can engage toggle pushbuttons 130g to activate or deactivate the “Show Country Holidays” feature of individual adjacent countries 130f respectively (i.e. pushbuttons 130g indicator read “ON” or “OFF” respectively).

When the “Show Country Holidays” feature of individual adjacent country 130f is activated (i.e. adjacent toggle pushbutton 130g reads “ON”), the alarm and calendar event management system allows: (i) all country holidays of that particular adjacent country 130f for selected target calendar year 130e to appear on a virtual calendar month display view (e.g. FIG. 18), and also (ii) enabling of the use of “Skip Active Recurring Alarm” feature (i.e. pushbuttons 130h will respond to any user's finger touching motion on it).

Similarly, when “Show Country Holidays” feature of an individual adjacent country 130f is deactivated (i.e. the adjacent toggle pushbutton 130g reads “OFF”), the alarm and calendar event management system will: (i) prevent the associated downloaded country holidays of the individual adjacent country 130f from appearing on a virtual calendar month screen view for particular adjacent country 130f and target calendar year 130e, and also (ii) disable the use of “Skip Active Recurring Alarm” feature entirely (i.e. the pushbutton 130h will not respond to any user's finger touching motion on it), effectively rendering that feature inoperable for downloaded country holidays of adjacent associated country 130f, through the automatic switching off of those downloaded country holidays' trigger mechanisms for skipping active recurring alarms (i.e. completely eliminating those downloaded country holidays' impact on any active recurring alarm that may fall on dates of those downloaded country holidays for the impacted adjacent country 130f and target calendar year 130e).

“Skip Active Recurring Alarm” feature becomes enabled (i.e. individual toggle pushbutton 130h can be switched to “ON or “OFF” by the user) by the alarm and calendar event management system only when the adjacent country's “Show Country Holidays” feature is switched on (i.e. toggle pushbutton 130g indicator reads “ON”).

When the “Skip Active Recurring Alarm” feature is switched on (i.e. the toggle switch button 130h reads “ON”) for associated downloaded country holidays of an adjacent associated country 130f, the alarm and calendar event management system responds by switching on those downloaded country holidays' trigger request mechanism so that any active recurring alarm that falls on a date that belongs to one of those downloaded country holidays for the impacted adjacent country 130f and target calendar year 130e, will be skipped when the following conditions are met: (i) such downloaded country holidays are currently identified to be a “Generally Observed Country Holiday” and (ii) the impacted adjacent country 130f is deemed to be a currently active country.

It is noted that currently active country holidays are essentially the entire list of holidays for a given calendar year for the currently active country. With the toggle switch 130h being “ON”, it can be interpreted as: the entire list of currently active country holidays of adjacent country and calendar year is eligible for skipping. However, it may happen that the entire list of currently active holidays OR only a subset are deemed as Currently Active Generally Observed Country Holidays based on the 3 criteria (i.e. holiday rule engine, user's own criteria, active country of holidays matching the system's time zone's) that are mentioned in the present patent application. In the context of the present patent application, the Currently Active Generally Observed Country Holidays can be interpreted as recognized holidays to the user, which are the only ones that can impact the recurring alarms. Any potentially leftover currently active country holiday that is not deemed as a Currently Active Generally Observed Country Holiday is not interpreted as a recognized country holiday, and furthermore, does not impact any active recurring alarm that may be active on the leftover holiday's date even though the toggle switch 130h is “ON”.

Similarly, when the “Skip Active Recurring Alarm” feature is switched off for downloaded country holidays of individual adjacent country 130f (i.e. pushbutton 130h indicator reads “OFF”), the alarm and calendar event management system responds by switching off the downloaded country holidays' trigger mechanism for skipping active recurring alarms, thereby, completely eliminating those downloaded country holidays' impact on any active recurring alarm that may fall on dates of those downloaded country holidays for the impacted adjacent country 130f and the target calendar year 130e. It is noted that a Country Holiday only affects a recurring alarm but not a personal alarm.

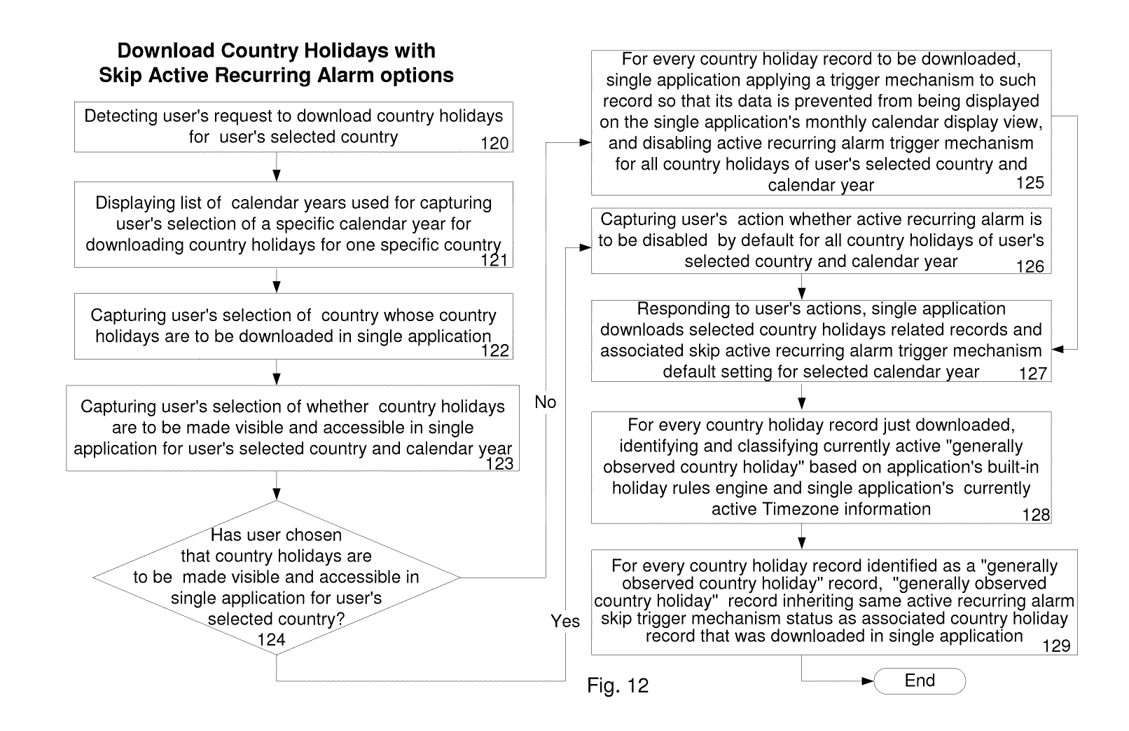

FIG. 12 is a flowchart illustrating an exemplary process for downloading country holidays for a specific country and a specific target calendar year, executed in an integrated alarm and calendar event management system in accordance with another embodiment of the present patent application. Referring to FIG. 12 and FIG. 13A, to download country holidays for a particular country (in our example, “Australia” (i.e. 130j)) for a given calendar year 130e, the user engages for a single time touch sensitive “+” link 130d, after which the alarm and calendar event management system responds by refreshing the mobile device display with an appropriate illustrative user interface with functions available to the mobile device user, from which the user performs the following activities sequentially: selecting and confirming a target calendar year 130e through a list of calendar years for the purpose of downloading country holidays of a specific target country; selecting and confirming a target country 130j for the purpose of downloading country holidays of such target country 130j and for the selected calendar year 130e.

Then, the alarm and calendar event management system responds by capturing target country 130j as the country for which to download country holidays for the selected calendar year 130e. After that, the alarm and calendar event management system responds by refreshing the device screen display with another appropriate illustrative user interface with functions available to the mobile device user (during the process of requesting for downloading of country holidays by the mobile device user for a selected target country (e.g. 130j) and target calendar year 130e), including the following: (i) individual selected target country 130j (i.e. Australia) for which country holidays are to be downloaded for the target calendar year 130e that the user has previously selected; (ii) a touch sensitive toggle pushbutton button (identical functionality as the one described for touch sensitive toggle pushbutton 130g) for enabling associated “Show Country Holidays” feature by the mobile device user for individual associated country 130j; (iii) a touch sensitive toggle pushbutton (identical functionalities as the one described for touch sensitive toggle pushbutton 130h) for enabling and disabling the associated “Skip Active Recurring Alarm” feature for the associated country's 130j downloaded country holidays and target calendar year 130e. After that, the alarm and calendar event management system responds by awaiting user's actions and confirmation of actions, followed by capturing the user's response.

Then, the mobile device user, if necessary, takes appropriate editing actions with respect to settings described in more detail hereafter, and confirms the information for the purpose of downloading country holidays of the target country 130j and the selected calendar year 130e.

After that, the alarm and calendar event management system responds by performing the following activities in the order they appear below: (i) capturing the mobile device user's confirmation and relevant information related to associated country holidays of the associated country 130j; (ii) remotely connecting to a holiday data services server or locally stored database and starting downloading those country holidays for the target country 130j from the remote server or local database to the alarm and calendar event management system; (iii) refreshing the device screen display with an appropriate illustrative user interface similar to the one shown in FIG. 13A, including the information reflecting the newly added country 130j (e.g. Australia) whose country holidays have been successfully downloaded, along with its setting information.

After the country holidays have been downloaded for the country 130j (e.g. Australia) for the selected calendar year 130e, the alarm and calendar event management system proceeds with the following activities: for every country holiday that is downloaded on the device during activities aforementioned, determine which one of those downloaded country holidays is identified as a currently active country holiday when all the following three conditions are met: a. the applicable calendar year associated with such downloaded country holiday is the same as the calendar year of the mobile device's operating system; b. the associated country 130j of the resulting downloaded country holidays that are identified matches the country of the alarm and calendar event management system's currently active time zone information; and c. the “Show Country Holidays” feature is activated (i.e. the toggle switch button 130g reads “ON”) for the resulting associated active country's 130j that is identified.

Immediately after the downloaded country holidays are identified, the alarm and calendar event management system proceeds with the following activities in the order they appear: (i) further proceeding with determining which ones of the resulting currently active country holidays are identified as currently active generally observed country holidays based on the alarm and calendar event management system's built-in holiday rules engine, along with the mobile device user's previous settings as illustrated in FIG. 13A (where applicable), and (ii) for every resulting currently active country holiday that is identified as a currently active generally observed country holiday, by virtue of inheritance, such country holiday also inherits the current prevailing skip recurring alarm trigger mechanism (i.e. status “ON” or “OFF” of toggle switch button 130h) that is currently associated with all country holidays of the resulting currently active country 130f for the current calendar year.

Immediately after mobile device user has confirmed the download of a particular country, the alarm and calendar event management system responds by proceeding with the activities as aforementioned, followed by refreshing the device screen with the illustrative user interface as shown in FIG. 13A with function as aforementioned.

Referring to FIG. 13A, in addition to the alarm and calendar event management system's country holiday rules engine that automatically determines generally observed country holidays, the alarm and calendar event management system also provides additional options that allow a mobile device user to individually identify other holiday attributes for determining generally observed country holidays via the touch sensitive “Advanced Options: Generally Observed Country Holiday” link 1301.

More specifically, when a mobile device user engages for a single time the “Advanced Options: Generally Observed Country Holiday” link 1301, the alarm and calendar event management system responds by refreshing the mobile device display with an illustrative user interface similar to the one shown in FIG. 13B.

FIG. 13B shows a mobile device 131a with a screen display 131b that displays an illustrative user interface that provides functions available to the mobile device user to further identify generally observed country holiday based on a country holiday's attribute (holiday type 131d). For instance, if the user activates the touch sensitive check box 131e (i.e. discernible marker shown as black circle) adjacent to “Bank” holiday type 131d, the alarm and calendar event management system, after the user has actually saved the information, will create a trigger mechanism so that all downloaded country holidays whose holiday type is a “Bank” for the specific associated calendar year 130e will be deemed as a Generally Observed Country Holiday.

Referring to FIG. 13B, when a mobile device user engages for a single time the “Close” link 131C, the alarm and calendar event management system will save any newly edited information on the screen, if any, and refresh the mobile device screen display back to the calling user interface (i.e. similar to the user interface as shown as in FIG. 13A).

For every currently active generally observed country holiday whose associated inherited skip recurring alarm trigger mechanism is currently activated (i.e. toggle switch button 130h reads “ON”), the alarm and calendar event management system will respond by enabling a skipping active recurring alarm trigger mechanism associated with the currently active generally observed country holiday so that any recurring alarm that may be active on that particular country holiday's calendar date will be disabled and not fire on that particular date.

For every currently active generally observed country holiday whose associated inherited skip recurring alarm trigger mechanism is currently deactivated (i.e. toggle switch button 130h reads “OFF”), the alarm and calendar event management system will respond by disabling a skipping active recurring alarm trigger mechanism associated with that currently active generally observed country holiday so that such currently active generally observed country holiday will not impact any active recurring alarm that may fall on that particular country holiday's calendar date.

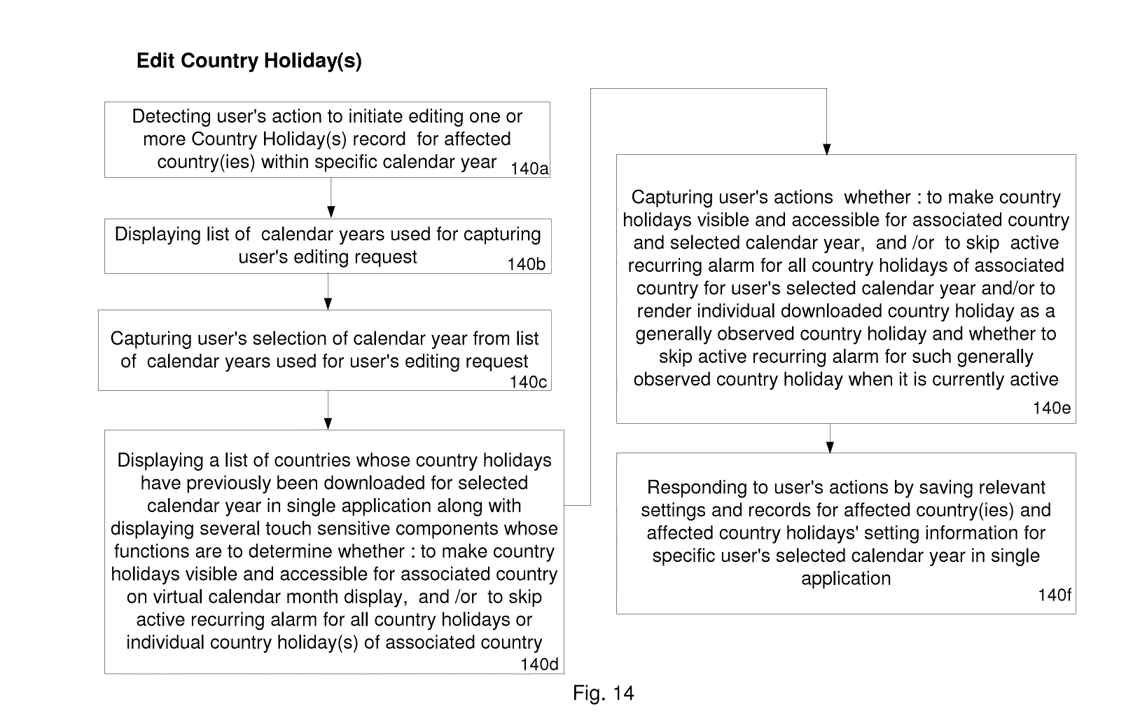

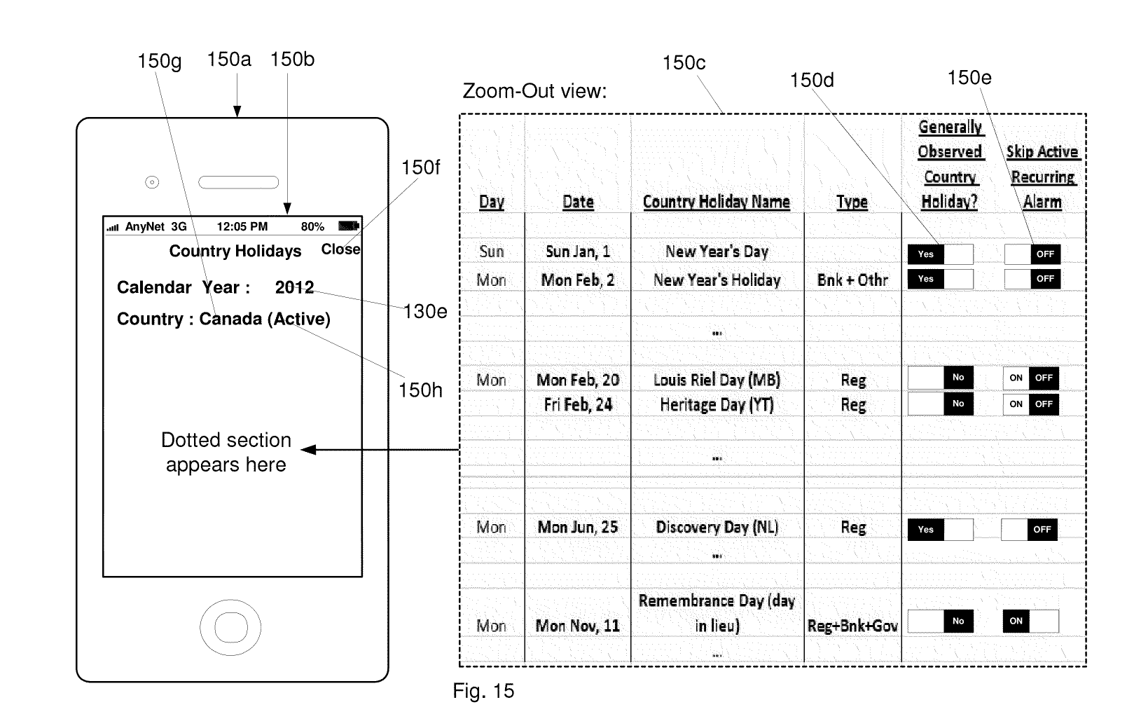

FIG. 14 is a block diagram illustrating an exemplary process of viewing and editing downloaded country holidays for a specific country and calendar year, including an option, where applicable, to individually identify the one(s) as “Generally Observed Country Holiday(s)”, each with the ability to skip recurring alarm on date that falls on the “Generally Observed Country Holiday”, executed in the alarm and calendar event management system. FIG. 15 shows a mobile device 150a with a screen display 150b that displays an illustrative user interface with functions available to the mobile device user when viewing individual downloaded country holidays for a specific country and a calendar year along with a schematic view of functions available to a user to (i) mark individual country holiday as a generally observed country holiday and (ii) edit individual country holiday's activation switch trigger for the purpose of preventing unwanted recurring alarm from firing on such country holiday whenever such holiday is also a currently active generally observed country holiday.

Moreover, while referring to FIG. 15, a status 150d reading of “Yes” (i.e. indicator 150d reads “Yes”) and “No” (i.e. indicator 150d reads “No”) identifies its adjacent Country Holiday as a Generally Observed Country Holiday and Not a Generally Observed Country Holiday respectively.

The status indicator 150d of whether an adjacent holiday is a Generally Observed Country Holiday is determined based on the alarm and calendar event management system's built-in holiday rules engine, the mobile device user's preset criteria (i.e. as illustrated in FIG. 13B), and the system's currently active time zone information.

Referring to FIG. 15, it is noted that listed country holidays being viewed for the specific calendar year 130e (i.e. 2012) are associated to a country 150g (e.g. Canada) that is an active country 150h (i.e. “Active” shown in bracket) at the time when the mobile device user is viewing.

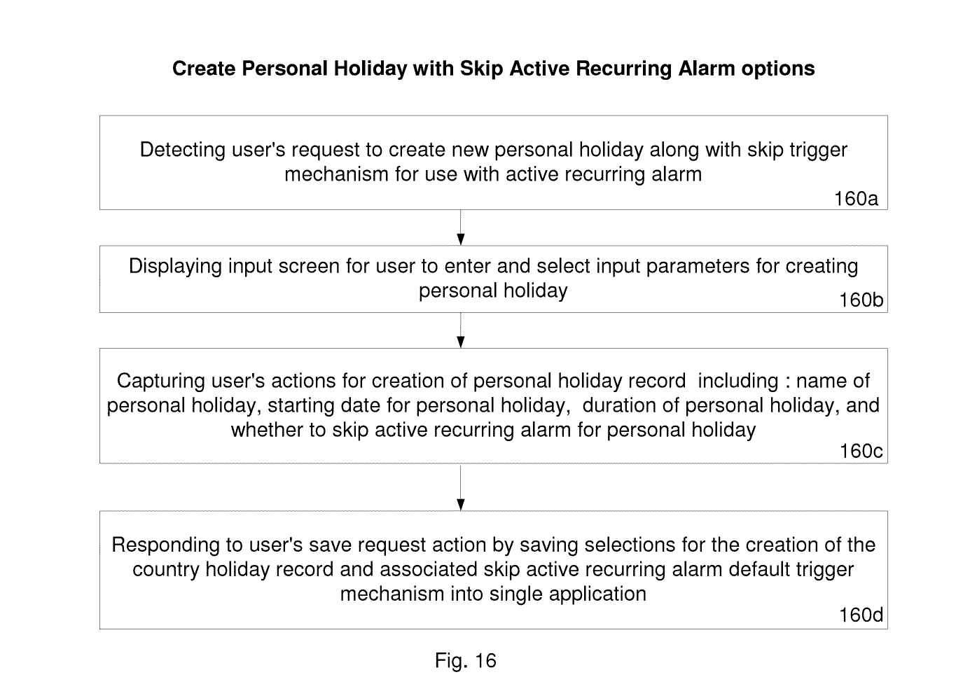

FIG. 16 is a flow chart illustrating a process of creating a user's personal holiday, including an option to trigger a mechanism to skip an active recurring alarm in the personal holiday's duration, executed by an alarm and calendar event management system according to another embodiment of the present patent application. Referring to FIG. 16, the process includes: detecting the user's request to create a new personal holiday along with a skip trigger mechanism to be used with an active recurring alarm (step 160a); displaying in the input screen for the user to enter and select input parameters for creating the personal holiday (step 160b); capturing the user's actions for creation of a personal holiday record that includes a name of the personal holiday, a starting date for the personal holiday, a duration of the personal holiday, and whether to skip the active recurring alarm for the personal holiday (step 160c); and responding to the user's saving request action by saving the selections for the creation of the country holiday record and the associated skip active recurring alarm default trigger mechanism into the alarm and calendar event management system.

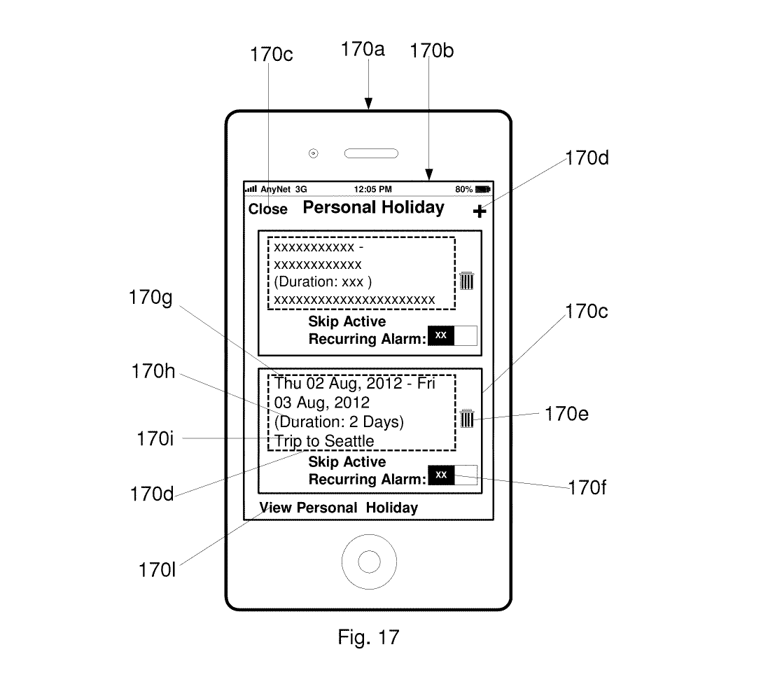

FIG. 17 shows a mobile device 170a with a screen display 170b that displays an illustrative user interface with functions available to the user to create a new personal holiday record, or edit or delete existing personal holiday records. Referring to FIG. 17, existing personal holiday blocks are displayed, with each block representing an individual existing personal holiday record in the alarm and calendar event management system, along with the following components associated with the personal holiday block 170c: a touch sensitive personal holiday's skip active recurring alarm trigger mechanism activation toggle switch 170f, a personal holiday's date range 170g, a personal holiday's duration 170h, a personal holiday's name 170i, a touch sensitive personal holiday region content section 170d, which, when being single tapped upon, allows the user to proceed with editing relevant personal holiday details (e.g. personal name, date(s), duration), and a touch sensitive delete personal holiday request link 170e.

Referring to FIG. 17, when the touch sensitive “Skip Active Recurring Alarm” feature is activated (i.e. activation toggle switch 170f associated with associated personal holiday indicator reads “ON”), the alarm and calendar event management system responds by enabling a skip active recurring alarm trigger mechanism to be associated with the personal holiday so that any recurring alarm that may be active during the personal holiday period 170g (e.g. between 2 Aug. 2012 and 3 Aug. 2012 inclusive) will be disabled and will not fire at all on such dates.

Similarly, referring to FIG. 17, when the touch sensitive “Skip Active Recurring Alarm” feature is deactivated (i.e. the activation toggle switch 170f associated with associated personal holiday indicator reads “OFF”), the alarm and calendar event management system responds by disabling a skip active recurring alarm trigger mechanism associated with the personal holiday so that such personal holiday will not impact any recurring alarm that may be active during the personal holiday period 170g (e.g. e.g. between 2 Aug. 2012 and 3 Aug. 2012).

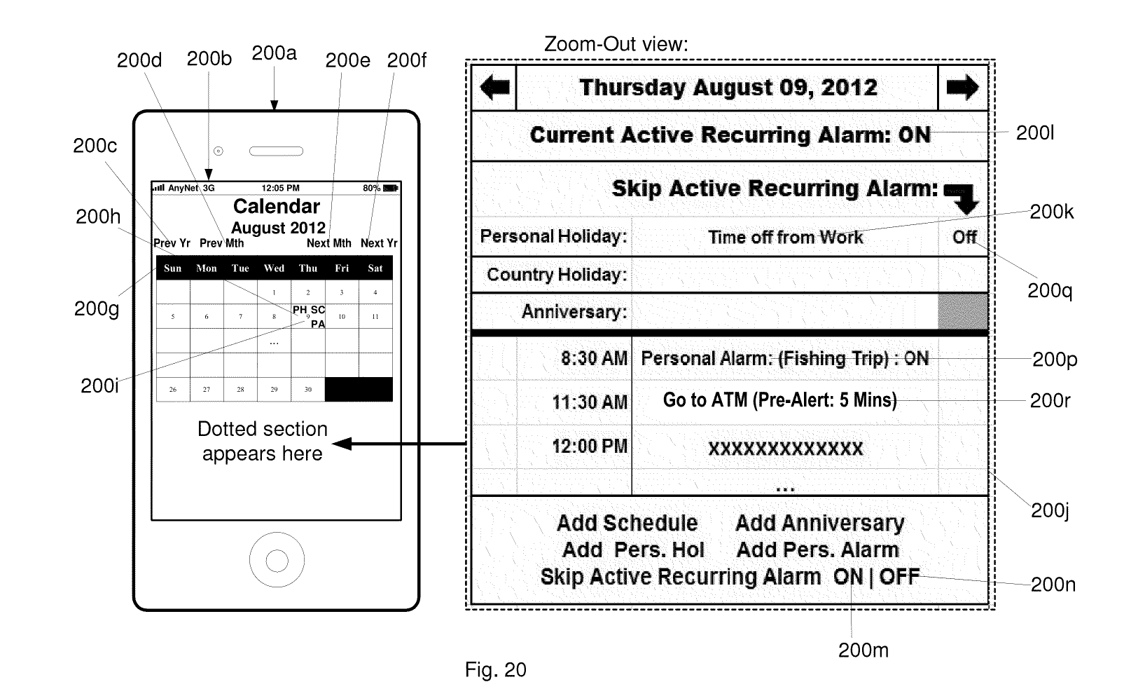

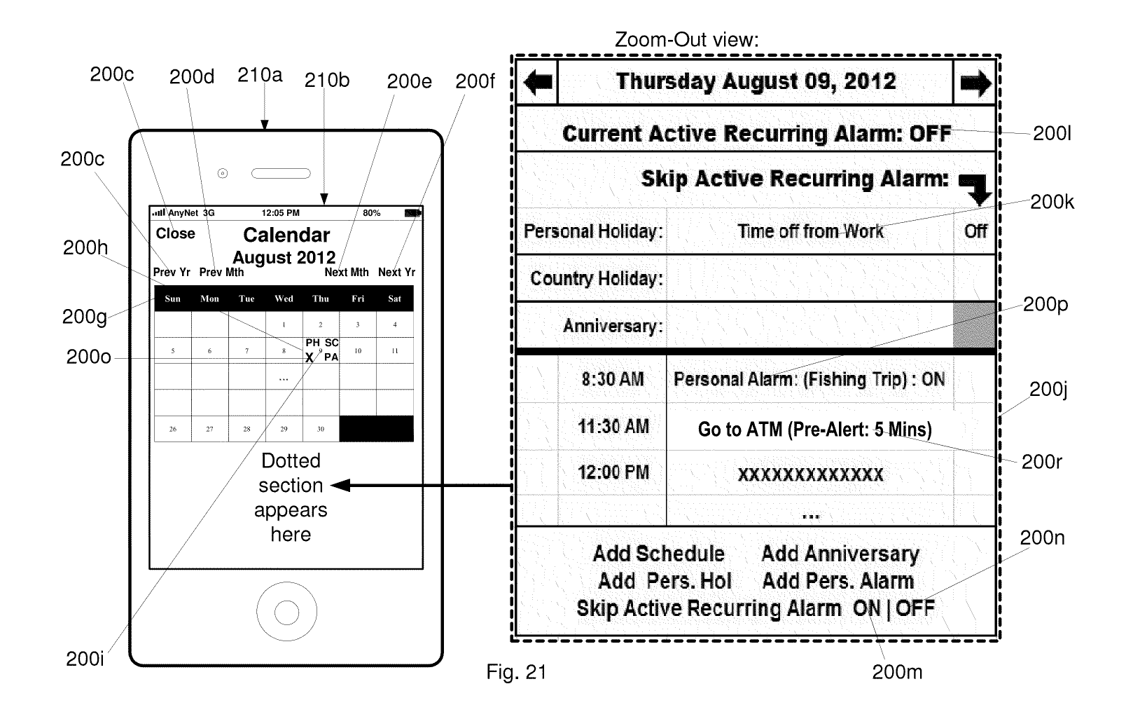

As shown in FIG. 18, FIG. 20, and FIG. 21, through the alarm and calendar event management system, a user can perform different operations to manage alarm and calendar events directly on a virtual calendar month view display as a starting point. Calendar events are denoted by unique discernible visual markers (e.g. graphical icon, colored date cell, acronyms) on the virtual calendar month view and pop-up daily calendar event window to help the user easily identify individual respective events. For instance, on the illustrative graphical user interface, for illustration purposes, “X”, “PH”, “CH”, “PA”, “SC”, and “AN” acronyms are being used throughout to represent a date with a skipped (i.e. disabled) active recurring alarm, a Personal Holiday, a Country Holiday, a Personal Alarm, a Schedule, and an Anniversary event respectively.

FIG. 18 shows a mobile device 180a with a screen display 180b that displays an illustrative user interface with functions available to a user while viewing a virtual calendar month display view 180h during which a user can make use of the display view 180h with touch sensitive date cells 180i being displayed on the mobile device in accordance with another embodiment of the present patent application. Furthermore, the device display shown in the illustrative user interface of FIG. 18 shows a daily calendar event pop-up window 180j showing all calendar events with touch sensitive text links (180k, 180m) for a particular target date (i.e. Apr. 9, 2012) being displayed on the mobile device.

Referring to FIG. 18, using the illustration example of the user interface showing the monthly calendar display view of the month of April 2012 on the mobile device display, a user can further engage for a single time respective touch sensitive: (i) link 180e to refresh the virtual monthly display, with each single engagement on the link 180e having the effect of refreshing the virtual monthly display view by one month (e.g. March 2012) previous to the currently displayed month (i.e. April 2012); (ii) link 180f to refresh the virtual monthly display view, with each single engagement on the link 180f by one month having the effect of refreshing the virtual monthly display view by one month (e.g. May 2012) subsequent to the currently displayed month (i.e. April 2012); (iii) link 180d to refresh the virtual calendar month display view, with each single tap on the link 180f having the effect of refreshing the virtual monthly display view by one year (e.g. 2011) previous to the currently displayed year (i.e. 2012); (iv) link 180g to refresh the virtual calendar month display view, with each single tap on the link 180g having the effect of refreshing the virtual monthly display view by one year (e.g. 2013) subsequent to the currently displayed year (i.e. 2012).

Referring to FIG. 18, an optional touch sensitive link 180u is available for a user to engage for a single time for displaying of a 7-day calendar week display view representation of the currently shown monthly calendar, with the weekly display view initially starting to show the first row (i.e. first week) of the current monthly display view 180h.

Referring to FIG. 18, if the user engages for a single time the touch sensitive date cell 180i, that will make the date associated with the date cell 180i become the current target date for skipping or reinstating active recurring alarm, adding new calendar events and/or viewing and editing existing events (e.g. personal holiday, personal alarm, schedule, anniversary, and etc.).

Referring to FIG. 18, when the user engages for a single time any touch sensitive individual date cell 180i (e.g. Apr. 9, 2012), the alarm and calendar event management system responds by displaying a movable calendar daily event pop-up window 180j for the target date that shows all calendar events for that date as shown in FIG. 18.

Referring to FIG. 18, a suitable representative visible marker 180c (e.g. “X” icon shown as “X” in this embodiment) is displayed for the target date (i.e. Apr. 9, 2012) associated with the date cell 180i to indicate an active recurring alarm is currently triggered to be skipped for the target date. In the embodiment depicted in FIG. 18, the source of the trigger is the country holiday event 180k whose “skip active recurring alarm:” indicator shows “ON” 1801. However, it is possible that there may have been more than one trigger source for the skipped recurring alarm as the trigger source may very well have come from one or more of the following events: personal holidays, generally observed country holidays, and the user's engaging for a single time a touch sensitive link 180r within a daily calendar pop-up window 180j.

For the ease of reference, in FIG. 18, the daily calendar event pop-up window 180j is displayed outside the screen display to make it easier to distinguish the components of the daily pop-up window 180j from those on the virtual calendar month view 180h.

Referring to the daily calendar event pop-up window 180j in FIG. 18, a user can further engage for a single time the following touch sensitive components: (i) link 180v to refresh the daily window display 180j, with each single engagement on the link 180v having the effect of refreshing the daily window display 180j by one day (e.g. Sunday Apr. 8, 2012) previous to the currently displayed daily window display 180j (i.e. Monday Apr. 9, 2012); (ii) link 180w to refresh the daily window display 180j, with each single engagement on the link 180w by one day having the effect of refreshing the daily window display 180j by one day (i.e. Tuesday Apr. 10, 2012) subsequent to the currently displayed date (i.e. Monday Apr. 9, 2012).

For every daily event pop-up window 180j being displayed for any particular target date, (i) when a user engages anywhere on the mobile device screen display outside the pop-up window 180j area, the daily event pop-up window will disappear from the mobile device display; (ii) when a user engages for a single time any other touch sensitive date cell on the monthly calendar display view 180h, the currently displayed daily event pop-up window will disappear from the mobile device display and another daily event pop-up window associated with the new target date (i.e. the newly tapped touch sensitive date cell) will appear on the mobile device display.

Moreover, in the context of the alarm and calendar event management system, referring to FIG. 18, as an example, every daily event pop-up window 180j being displayed for any particular target date includes static touch sensitive trigger links (i.e. 180n, 180o, 180p, 180q, 180r, 180s). Table 1 below shows the alarm and calendar event management system's response when a user engages for a single time the following touch sensitive static links denoted by respective markers.

TABLE 1

| Static link | Action by the alarm and calendar event management system |
|---|---|
| 180n | Displaying an appropriate user interface with functions to |
| | allow the user to create a new schedule for the target date, |
| | with the schedule's date initially being defaulted to the |
| | target date on the user interface. |
| 180o | Displaying an appropriate user interface with functions to |
| | allow the user to create an anniversary date, with the anni- |
| | versary's date initially being defaulted to the target date |
| | on the user interface. |
| 180p | Displaying an appropriate user interface with functions to |
| | allow the user to create a new personal holiday for the target |
| | date, with the personal holiday's starting date initially |
| | being defaulted to the target date on the user interface. |
| 180q | Displaying an appropriate user interface with functions to |
| | allow the user to create a new personal alarm for the target |
| | date, with the personal alarm's date initially being |
| | defaulted to the target date on the user interface. |
| 180r | If Current Condition: Target Date with no existing Skipped |
| | Active Recurring Alarm; |
| | User's Action: Skipping an Active Recurring Alarm on a |
| | Virtual Calendar Month Display View; |
| | System's Response: Enabling a skip trigger mechanism to |
| | program the target date's active recurring alarm to be |
| | skipped, followed by refreshing virtual monthly calendar |
| | view with a suitable representative icon (e.g. “X” icon) |
| | (200o from FIG. 21) to indicate a currently active recur- |
| | ring alarm is now programmed to be skipped for the target |
| | date. |
| | If Current Condition: Target Date with already existing |
| | Skipped Active Recurring Alarm; |
| | User's Action: Skipping an Active Recurring Alarm on a |
| | Virtual Calendar Month Display View; |
| | System's Response: Displaying a notification message that |
| | the target date already has an existing active recurring alarm |
| | programmed to be skipped and that user's action would have |
| | no impact on any existing active recurring alarm for that |
| | date. |
| 180s | If Current Condition: Target Date with no existing Skipped |
| | Active Recurring Alarm; |
| | User's Action: Reinstating an Active Recurring Alarm on a |
| | Virtual Calendar Month Display View |
| | System's Response: Displaying a suitable notification |
| | message that the target date does not currently hold any |
| | skipped active recurring alarm and user's action will have no |
| | impact on any existing active recurring alarm for that date. |
| | If Current Condition: Target Date with already existing |
| | Skipped Active Recurring Alarm; |
| | User's Action: Reinstating an Active Recurring Alarm on |
| | a Virtual Calendar Month Display View; |
| | System's Response: Removing any currently active skip |
| | trigger mechanism that is caused by a prior manual skip |
| | operation on the calendar event pop-up window. However, |
| | immediately after the removal operation, if alarm and |
| | calendar event management system detects there are still |
| | other active skip active recurring alarm trigger mechanism(s) |
| | arising from other calendar event(s), the alarm and calendar |
| | event management system will display a notification |
| | message to indicate that the target date still has existing |
| | active recurring alarm currently programmed to be skipped. |

In the illustrative user interface shown in FIG. 18, the first calendar event 180k is a country holiday (i.e denoted by “CH” on the date cell 180i) that applies to the following countries: Australia, Canada, Hong Kong, and USA whose country holidays have been loaded for those countries for the target date, with Canada being the currently active country (e.g. Canada shown with * denoting it as the currently active country). In addition, the embodiment also indicates that although that date is designated as a country holiday for the currently active country, Canada, assuming that day holds an active recurring alarm, the active recurring alarm will not fire at all at the designated time for that day because the current active recurring alarm indicator is currently reading “OFF” 180t (i.e. “Current Active Recurring Alarm: OFF”) for the currently active country. It is noted that the current active recurring alarm has been disabled by the country holiday event 180k since its skip active recurring alarm trigger mechanism 1801 is “ON” (i.e. Skip Active Recurring Alarm: “ON”).

Referring to FIG. 18, for example, when the mobile device user engages for a single time any individual touch sensitive country holiday event 180k (e.g. Australia, Canada*, Hong Kong, USA), the alarm and calendar event management system responds by displaying another illustrative user interface displaying the target date's country holiday details.

Referring to FIG. 18, when the user engages for a single time the “Close” text link 180 cc, the alarm and calendar event management system refreshes the mobile device display with an appropriate user interface from which the current user interface (i.e. user interface as shown in FIG. 18) is called.

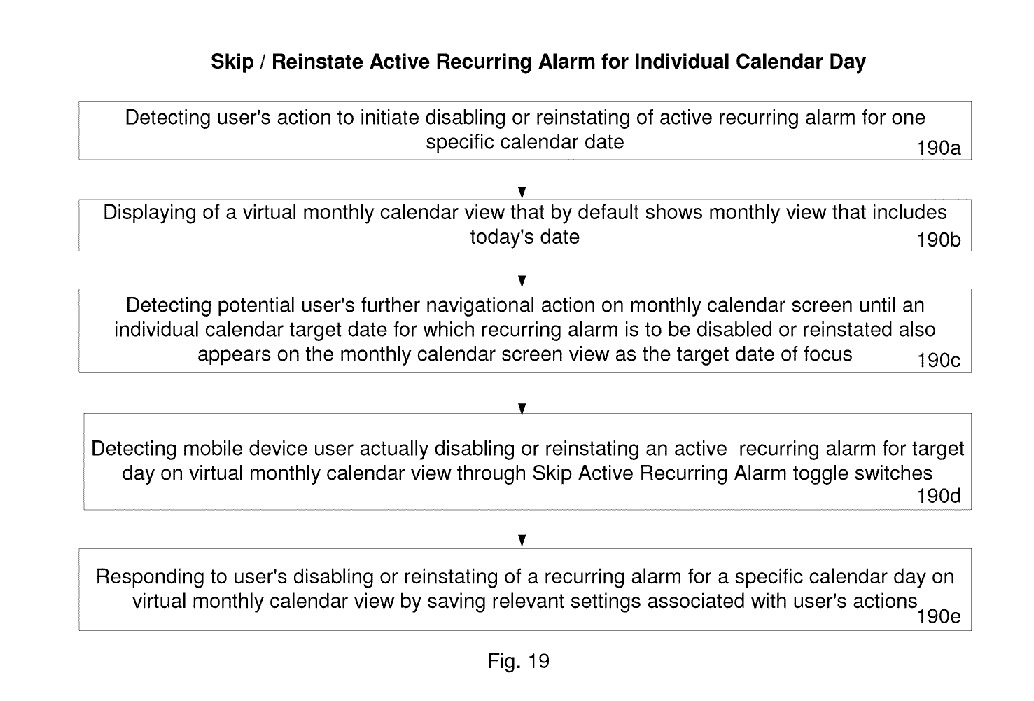

FIG. 19 is a flowchart illustrating a process of skipping or reinstating of an active recurring alarm via a virtual calendar monthly view, executed by an alarm and calendar event management system according to another embodiment of the present patent application. Referring to FIG. 19, the process includes: detecting a user's action to initiate disabling or reinstating of an active recurring alarm for one specific calendar date (step 190a); displaying of a virtual monthly calendar view that by default shows a monthly view that includes today's date (step 190b); detecting the user's further navigational action on the monthly calendar screen until an individual calendar target date for which the recurring alarm is to be disabled or reinstated also appears on the monthly calendar screen view as the target date of focus (step 190c); detecting the user's actually disabling or reinstating an active recurring alarm for the target date on the virtual monthly calendar view through Skip Active Recurring Alarm toggle switches (step 190d); and responding to the user's disabling or reinstating the recurring alarm for the specific calendar date on the virtual monthly calendar view by saving relevant settings associated with the user's actions (step 190e).

FIG. 20 shows a mobile device 200a with a screen display 200b that displays an illustrative user interface showing calendar event(s) 200k for a specific target date 200i (i.e. Aug. 9, 2012), listed inside a calendar daily event pop-up window 200j that further sits on top of a virtual calendar month display 200g with a specific date cell 200h representing a specific target date with no skipped active recurring alarm (i.e. Current Active Recurring Alarm=“ON” 2001) triggered for the target date.

Referring to FIG. 20, if a user taps on the touch sensitive “Skip Active Recurring Alarm ON” text link 200m within the pop-up window for the target date, the alarm and calendar event management system responds by enabling a skip trigger mechanism to program the target date's active recurring alarm to be skipped, followed by refreshing virtual monthly calendar view with a suitable representative visible marker 200o (e.g. “X” icon) as shown in FIG. 21 to indicate a currently active recurring alarm is now programmed to be skipped for the target date.

Referring to FIG. 20, if user taps on the touch sensitive “Skip Active Recurring Alarm OFF” text link 200n within the calendar event pop-up window for the target date, the alarm and calendar event management system responds by displaying a notification message that the target date does not currently hold any skipped active recurring alarm and the user's action will have no impact on any existing active recurring alarm for that date.

FIG. 21 shows a mobile device 210a with a screen display 210b that displays an illustrative user interface showing calendar event(s) 200k for a specific target date 200i, listed inside a calendar daily event pop-up window 200j that further sits on top of a virtual calendar month display view 200g with a specific date cell 200h representing the target date that already has one or more currently activated skip trigger mechanism triggered by one or more calendar events (i.e. a country holiday event, personal holiday event, manual skip alarm operation arising directly from within the daily event pop-up window) represented by an appropriate Skip Active Recurring Alarm indicator icon (e.g. shown as “X”) 200o that will be shown inside the affected target date cell. The activated skip trigger mechanism also causes the current active recurring alarm indicator to read as “OFF” for the target date (i.e. Current Active Recurring Alarm=“OFF” 200l).

Referring to FIG. 21, if a user taps on touch sensitive “Skip Active Recurring Alarm ON” text link 200m, the alarm and calendar event management system responds by displaying a notification message that the target date already has an existing active recurring alarm programmed to be skipped and that user's action will have no impact on any existing active recurring alarm for that date.

Referring to FIG. 21, if a user taps on the touch sensitive “Skip Active Recurring Alarm OFF” text link 200n, the alarm and calendar event management system responds by removing any currently active skip trigger mechanism that is caused by a prior manual skip operation on the calendar event pop-up window. However, immediately after the removal operation, if the alarm and calendar event management system detects there are still other active skip active recurring alarm trigger mechanism(s) arising from other calendar event(s) (e.g. Personal Holiday), the alarm and calendar event management system will display a notification message to indicate that the target date still has existing active recurring alarm programmed to be skipped for the current target date (i.e. the visible marker “X” 200o as shown in FIG. 21 will still be present on the virtual calendar month display view 200g). For example, a personal holiday may have been created for the target day by the user, whose “Skip Active Recurring Alarm” trigger switch mechanism is also already ON for that day. In this kind of situation, when a user taps on “Skip Active Recurring Alarm OFF” link 200n on the pop-up screen, the alarm and calendar event management system will display a notification message: “Skip Active Recurring Alarm already exists for one or more event(s) for that day. Please change “Skip Active Recurring Alarm” indicator for the affected event(s) to “OFF” if you still wish to allow Active Recurring Alarm to fire for that day.”

In the illustrative user interface as shown in FIG. 20, the first calendar event 200k is a personal holiday (i.e. denoted by “PH” in the date cell 200i) that applies to the target date. Assuming that date holds an active recurring alarm, the active recurring alarm will fire at the appointed time for that date because the current active recurring alarm indicator is currently reading “ON 200l (i.e. “Current Active Recurring Alarm: ON”). It is also noted that the current active recurring alarm has not been disabled by the personal holiday event as indicated by its skip active recurring alarm trigger mechanism indicator 200q (i.e. Skip Active Recurring Alarm: “OFF”) or by any other calendar events for that matter, and hence the personal holiday event has no impact on any active recurring alarm for the target date.

Referring to the first calendar event 200k in FIG. 20, if a user engages for a single time the touch sensitive personal holiday event 200k for the target date, the alarm and calendar event management system responds by displaying another illustrative user interface for further viewing and/or editing details of the personal holiday event 200k.

Referring to FIG. 20, if the user taps on the touch sensitive text link which happens to be a personal alarm event 200p (i.e. Fishing Trip) for the target date, the alarm and calendar event management system responds by displaying another illustrative user interface for further viewing and/or editing details of the personal alarm event.

For another example, if a mobile device user engages for a single time the touch sensitive text link 200r that happens to be associated with a schedule event (i.e. Schedule's Name: Go to ATM) for the target date, the alarm and calendar event management system responds by displaying another illustrative user interface with functions available to the mobile device user to further view and/or edit details of that schedule event for the target date.

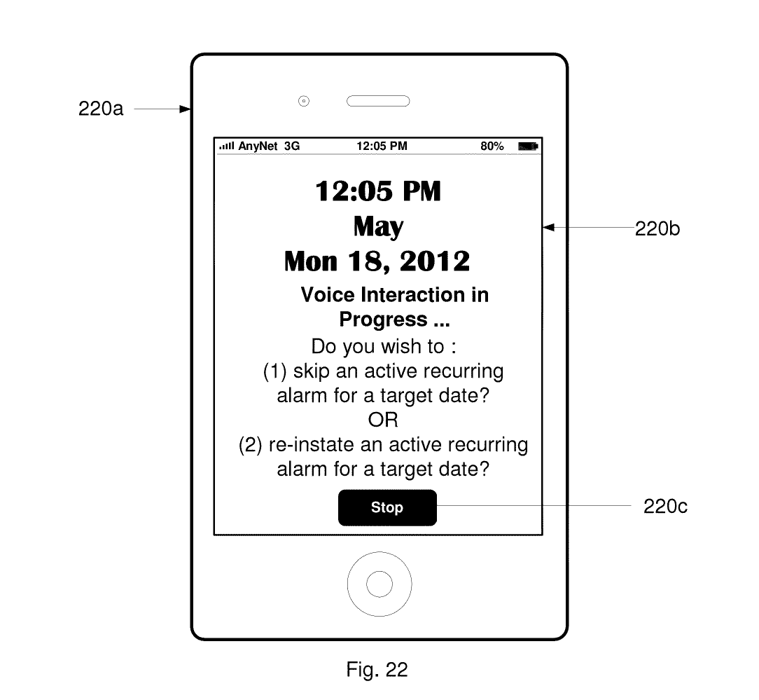

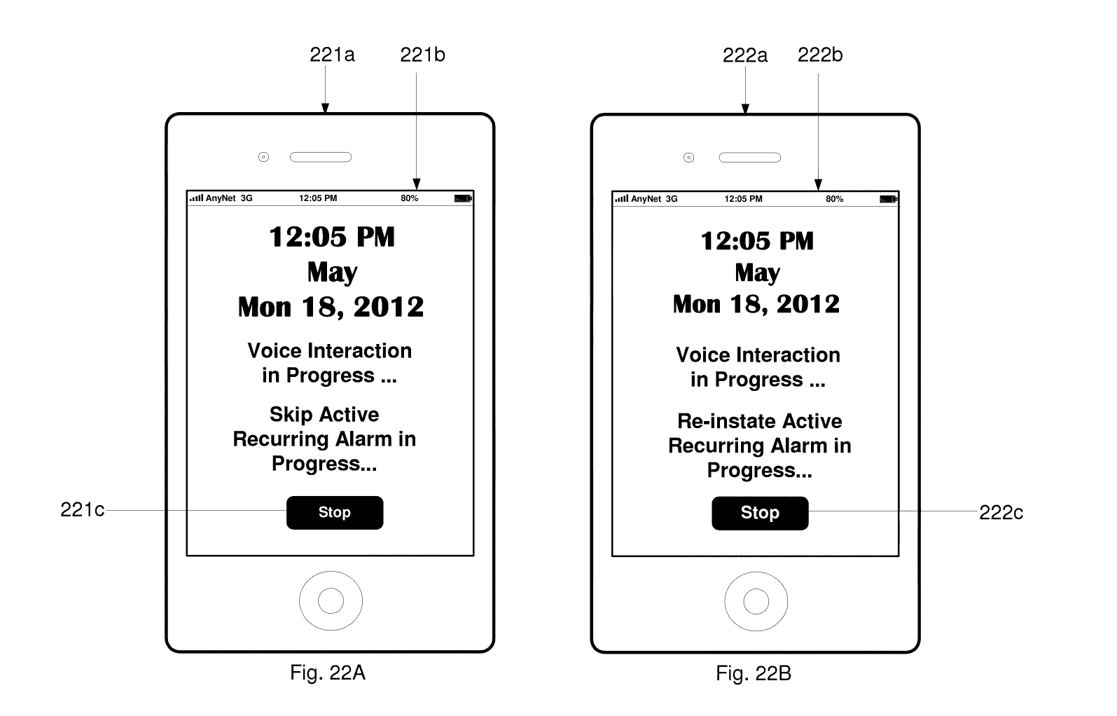

FIG. 22 shows a mobile device 220a with a screen display 220b showing an illustrative user interface of an alarm and calendar event management system initiating an appropriate voice-enabled recognition and interaction program asking the user whether the user wishes to skip or reinstate a particular recurring alarm for a specific calendar date through voice interaction means between the user and the alarm and calendar event management system via the mobile device's audio system according to another embodiment of the present patent application.

Referring to FIG. 22, if a user engages for a single time touch sensitive “Stop” pushbutton 220c while the disabling/reinstating of active recurring alarm request voice interaction main program is in progress, the alarm and calendar event management system will respond by canceling the current user's request, followed by refreshing the mobile device display with the calling user interface that called the current user interface.

FIG. 22A shows a mobile device 221a with a screen display 221b showing an illustrative user interface during the execution of the alarm and calendar event management system's skip active recurring alarm request voice interaction program for the purpose of disabling of an active recurring alarm for a specific calendar date, arising from the user's request, using a combination of voice and text interaction between the user and alarm and calendar event management system via the mobile device's audio system.

Referring to FIG. 22A, if a user engages for a single time the touch sensitive “Stop” pushbutton 221c while the disabling (i.e. skipping) active recurring alarm request voice interaction program is in progress, the alarm and calendar event management system will cancel the current user's request and refreshes the mobile device display with the calling user interface that calls the current user interface.

Referring to FIG. 22A, the process shown below describes the voice interaction process steps executed in the alarm and calendar event management system's appropriate voice interaction request program for the skipping activity of an active recurring alarm for a target date during voice interaction activity between the alarm and calendar event management system and the user:

1. Announcing through the mobile device's appropriate voice activated audio system channel the start of the alarm and calendar event management system's voice interactive request program for skipping an active recurring alarm for a target date;

2. Detecting the user's voice activated action to initiate a request for disabling active recurring alarm for a particular calendar date (i.e. target date);

3. Instructing the user to provide respective parameter input(s) in an audibly acceptable format to the alarm and calendar event management system related to but not limited to: a target date for which to disable an active recurring alarm, until the alarm and calendar event management system is able to detect the user's audible target date, after which the alarm and calendar event management system proceeds to step 4; failure in detecting user's audible date within a pre-determined time-out period will lead to the alarm and calendar event management system terminating the user's voice activated request and exiting the current voice activated skipping recurring alarm request completely;

4. Upon detecting an acceptable audible date from the user, processing date information and verifying if there is already an active recurring alarm set to be skipped for the target date;

5. During the verification as stated in step 4 above,

5.1. Detecting that there is already an active recurring alarm set to be skipped for the requested target date (i.e. the active recurring alarm will not fire on that date);

5.1.1. Responding with an audible notification along with an associated text notification message that a skipped active recurring alarm already exists for the requested target date after which the alarm and calendar event management system proceeds to step 6 below;

5.2. Detecting that requested target date does not already have a skipped active recurring alarm (i.e. active recurring alarm will fire on that date);

5.2.1. Instructing the user to confirm that the user wishes to skip active recurring alarm for the requested date until user's audible reply is detected after which the alarm and calendar event management system proceeds to step 5.2.2; Failure in detecting user's audibly acceptable reply within a predetermined time-out period will lead to the alarm and calendar event management system terminating user's voice activated request and exiting current voice activated skip recurring alarm request program completely;

5.2.2. Upon detecting an acceptable audible answer from the user, the alarm and calendar event management system processes the user's answer:

5.2.2.1. Upon detecting an affirmative audible answer from the user (i.e. “Yes”), setting up active recurring alarm to be bypassed for the target date and saving related database record(s), followed by confirming through a voice notification message along with an associated text notification message that Active Recurring Alarm has just been set up to be skipped for the user's requested target date;

OR

5.2.2.2. Upon detecting a negative audible answer from the user (i.e. “No”), terminating the user's voice activated request, followed by notifying the user by voice notification message along with the associated text notification message showing that the user's request to skip the Active Recurring Alarm has been canceled for the target date;

6. Asking by voice interaction means whether the user wishes to initiate additional disabling of active recurring alarm activities until detecting the user's audible reply that is acceptable to the alarm and calendar event management system after which it proceeds to step 7; Failure in detecting user's audible reply within a pre-determined time-out period will lead to the alarm and calendar event management system terminating current disabling request and exiting current disabling of active recurring alarm voice interactive request program completely;

7. Processing audible reply to the alarm and calendar event management system's voice interactive question from step 6:

7.1. Upon detecting an affirmative audible answer (i.e. “Yes”) from the user, starting processing another voice interactive user's request to skip an active recurring alarm from the step 3 above;

OR

7.2. Upon detecting a negative audible answer (i.e. “No”) from the user, terminating the voice activated request activity and exiting the current voice activation request program completely.

FIG. 22B shows a mobile device 222a with a screen display 222b showing an illustrative user interface during the execution of the alarm and calendar event management system's voice interaction reinstating of active recurring alarm request program for the purpose of reinstating of an active recurring alarm for a specific calendar date, arising from the user's request, using a combination of voice and text interactions between the user and the alarm and calendar event management system via the mobile device's audio system, executed on by the alarm and calendar event management system in accordance with another embodiment of the present patent application.

Referring to FIG. 22B, if a user engages for a single time touch sensitive “Stop” pushbutton 222c while the reinstating of active recurring alarm request's voice interaction program is in progress, the alarm and calendar event management system will cancel the current user's request and refreshes the mobile device display with the calling user interface that called the current user interface.

Referring to FIG. 22B, the process shown below describes the voice interaction process steps executed in the alarm and calendar event management system's appropriate voice interaction request program for the reinstating activity of an active recurring alarm for a target date during voice interaction activity between the alarm and calendar event management system and the user.

1 Announcing through the mobile device's appropriate voice activated audio system channel the start of the alarm and calendar event management system's voice interactive request program for reinstating of active recurring alarm for a target date;

2. Detecting user's voice interaction action to initiate a request for reinstating an active recurring alarm for a particular calendar date (i.e. target date);

3. Instructing the user to provide respective parameter input(s) in an audibly acceptable format to the alarm and calendar event management system related to but not limited to: the target date for which to reinstate an active recurring alarm, until the alarm and calendar event management system detects the user's audible target date, after which the alarm and calendar event management system proceeds to the step 4 below; failure in detecting user's audible date within a pre-determined time-out period will lead to the alarm and calendar event management system terminating user's voice interaction request and exiting the current voice interactive recurring alarm reinstating request completely;

4. Upon detecting an acceptable audible date from the user, processing the date information and verifying if there is already an active recurring alarm set to be skipped for the target date;

5. During the verification as stated in the step 4 above:

5.1. Detecting that the requested target date does not already have a skipped active recurring alarm (i.e. an active recurring alarm will not fire on that date):

5.1.1. Responding with an audible notification along with an associated text notification message showing that no skip activation currently exists for the active recurring alarm for the requested date after which the alarm and calendar event management system proceeds to the step 6 below;

5.2. Detecting that there is already an active recurring alarm set to be skipped for the requested target date (i.e. active recurring alarm will fire on that date):

5.2.1. Instructing the user to confirm that the user wishes to reinstate the active recurring alarm for the requested date until the user's audible reply is detected after which the alarm and calendar event management system proceeds to step 5.2.2; failure in detecting the user's audibly acceptable reply within a predetermined time-out period will lead to the alarm and calendar event management system terminating user's voice activated request and exiting the current reinstating of the active recurring alarm voice interactive request program completely;

5.2.2. Upon detecting an acceptable audibly reply from the user, processing the user's audible answer:

5.2.2.1. Upon detecting an affirmative answer from the user (i.e. “Yes”), setting up the active recurring alarm to be reinstated for the user's requested date and saving the relevant database record(s), followed by confirming through voice notification message along with an associated text notification message showing that the Active Recurring Alarm has just been reinstated for the user's requested target date after which the time alarm and calendar event management system proceeds to step 6;

OR

5.2.2.2. Upon detecting an negative answer from the user (i.e. “No”), terminating the user's voice activated request, followed by the alarm and calendar event management system notifying the user by voice notification message along with an associated text notification message showing that the request to skip Active Recurring Alarm has been canceled for the user's requested target date after which the alarm and calendar event management system proceeds to step 6;

6. Asking through the voice interaction channel whether the user wishes to initiate another reinstating of active recurring alarm activities until the alarm and calendar event management system detects the user's audible reply that is acceptable to the alarm and calendar event management system after which it proceeds to step 7; failure in detecting the user's audible reply within a predetermined time-out period will lead to the alarm and calendar event management system terminating current reinstating request and exiting the current reinstating of active recurring alarm voice interactive request program completely;

7. Processing user's audible reply to the alarm and calendar event management system's voice interactive question from step 6:

7.1. Upon detecting an affirmative answer (i.e. “Yes”) from the user, starting processing another request to reinstate an active recurring alarm from the step 3 above;

OR

7.2. Upon detecting a negative answer (i.e. “No”) from the user, terminating the user's voice activated request and exiting the current reinstating of active recurring alarm voice interactive request program completely.

According to another embodiment of the present patent application, to allow an alarm and calendar event management system's recurring alarm and related events on a mobile device (e.g. a smartphone device) to be shared and synchronized among other mobile devices (e.g. wristwatch devices, tablets, etc.) that house the same alarm and calendar event management system, a User Data Instance and a User Authentication Profile (UAP) are introduced, both of which are built-in components in the alarm and calendar event management system, with the purpose of providing a mobile device user the ability to automatically or manually synchronize a User Data Instance of the alarm and calendar event management system among other devices.

In this embodiment, an alarm and calendar event management system's User Data Instance, is a consolidated data file inside the alarm and calendar event management system that primarily holds a set of specific calendar based and recurring alarm related events, which have direct impact on the prevailing recurring alarms in the alarm and calendar event management system, the events including: recurring alarms, skipped recurring alarms, personal holidays, and country holidays.

A User Data Instance has great relevance to the alarm and calendar event management system's Controlling UAP (referring to the definition below), for the purpose of synchronization the User Data Instance among devices whose alarm and calendar event management systems share the identical Controlling UAP.

Through a shared User Data Instance, the user(s) of the mobile devices whose alarm and calendar event management system share the identical User Data Instance will be able see and use the same set of recurring alarm related events that are encapsulated in the User Data Instance.

Examples of calendar based or recurring alarm related events that have direct impact on prevailing recurring alarm include, but not limited to: confirmation of a new download of country holidays, update of a personal holiday, update of a recurring alarm setup, skipping of a recurring alarm for a specific date on a calendar view, etc.

A user authentication profile (UAP), in the context of the alarm and calendar event management system, can take the form of: (i) a non-biometric UAP employing the use of a unique username and associated password, and (ii) a biometric UAP employing the mobile device user's thumbprint capture, the user's eye retina mapping, or any other suitable prevailing and commonly used technologies.

A Non-biometric user authentication profile (UAP) is one that holds authentication information such as a unique individual username and the associated password, incorporated into the user authentication profile within an alarm and calendar event management system.

A biometric user authentication profile (UAP) is one that holds authentication information such as an individual person's biometric feature such as person's thumbprint or eye mapped composition, incorporated into the user authentication profile within an alarm and calendar event management system.

A controlling UAP inside an alarm and calendar event management system is one that the alarm and calendar event management system recognizes at any given time, for the purpose of synchronization activities among devices whose alarm and calendar event management system share the same controlling UAP, through an established wireless connection and also via a central repository storage employing cloud based server technologies.

With a Controlling UAP (biometric or otherwise), an alarm and calendar event management system's current user, whose own authentication information matches the one inside the controlling UAP currently residing inside the alarm and calendar event management system, is the only user who will be allowed by the alarm and calendar event management system to delete such controlling UAP. Therefore, whichever user whose own authentication information matches the one inside the controlling UAP in the alarm and calendar event management system, is the user who will be allowed by the alarm and calendar event management system to release (i.e. delete) his or her controlling UAP in the alarm and calendar event management system in order to allow another user to create his/her own user UAP.

Moreover, an alarm and calendar event management system can also be activated with the use of a controlling UAP as a means of user authentication before such user is allowed to start using the alarm and calendar event management system altogether. It is with the assumption that an alarm and calendar event management system in any given mobile device will be used by one individual user (i.e. calendar, holidays, and alarm related events stored in the alarm and calendar event management system applicable to only one individual person) at one given time, just like any calendar or alarm clock application in a mobile device.

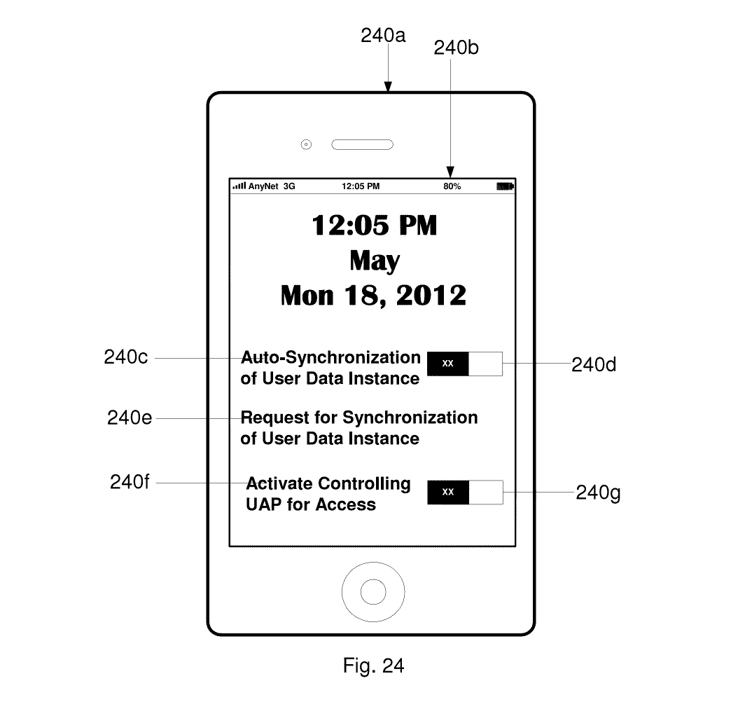

FIG. 24 shows a mobile device with a screen display that displays an illustrative user interface with functions relating to the synchronization related activities and user access control to the alarm and calendar event management system through the Controlling UAP according to another embodiment of the present patent application. Referring to FIG. 24, in order to activate the Controlling UAP for the purpose of controlling access to the alarm and calendar event management system via authentication means, a mobile device user activates the “Activate Controlling UAP for Access” feature 240f by engaging touch sensitive toggle switch 240g adjacent to it until its toggle switch's indicator reads “ON”.

Following the completion of the aforementioned activities, with the “Activate Controlling UAP for Access” feature 240f activated, depending on the nature of the authentication type (biometric or Non-biometric type) in the alarm and calendar event management system's controlling UAP, the alarm and calendar event management system's user provides his or her authentication information through an appropriate user interface using either Non-biometric UAP means (e.g. username and password) or biometric UAP means (biometric sensor) for validation against the alarm and calendar event management system's authentication data encapsulated inside the controlling UAP.

After that, the alarm and calendar event management system captures the user's actions, followed by validating the user entered information with information currently being stored in the alarm and calendar event management systems' controlling UAP.

Upon successful validation, the alarm and calendar event management system refreshes the mobile device display with the alarm and calendar event management system's main screen user interface similar to the one shown in FIG. 2, with functions available for the user to use.

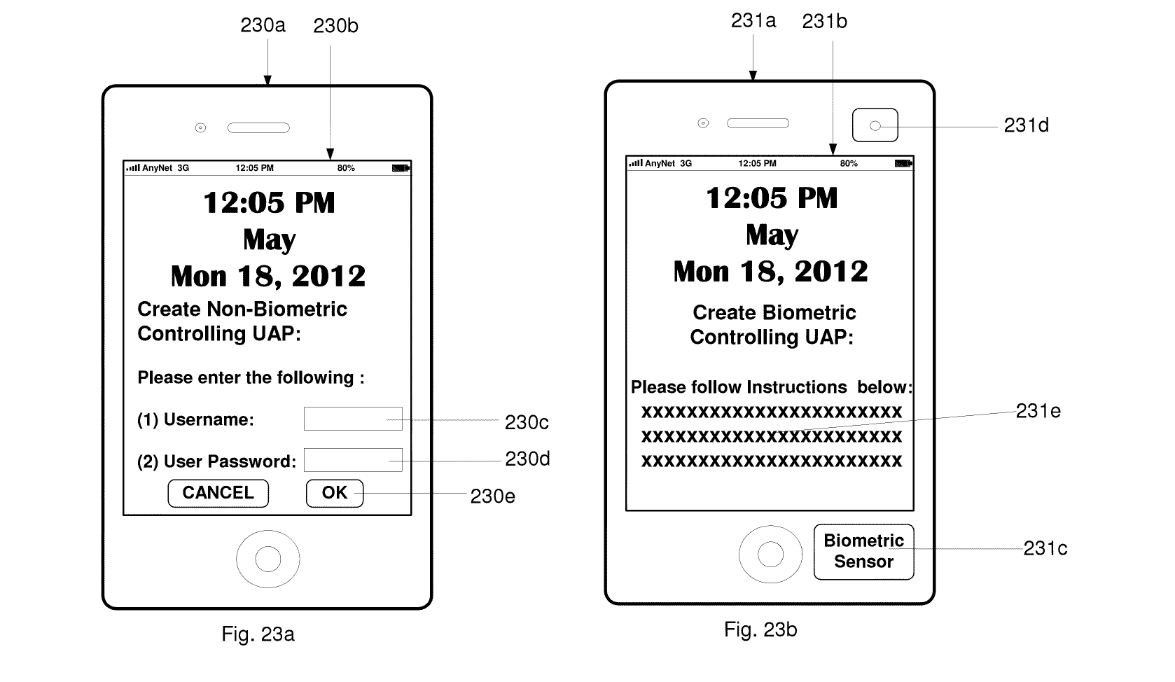

FIG. 23A shows a mobile device 230a with a screen display 230b that displays an illustrative user interface with functions to allow a mobile device user to create a unique non-biometric controlling UAP in the alarm and calendar event management system, if no controlling UAP currently exists inside the alarm and calendar event management system. Referring to FIG. 23A, the alarm and calendar event management system user enters a unique username 230c and the associated password 230d, followed by confirming the entered information, via touch sensitive “OK” button 230e.

After that, the alarm and calendar event management system captures the user's actions, and associates and incorporates the user entered and captured information to be used as the alarm and calendar event management system's non-biometric UAP for the current alarm and calendar event management system user, followed by refreshing the mobile device display with a notification message of successful capture of the controlling UAP, while awaiting user's acknowledgement.

Then, the user acknowledges the alarm and calendar event management system's notification message, after which the alarm and calendar event management system refreshes the mobile device display with the calling interface that called the current user interface as aforementioned.

FIG. 23B shows a mobile device 231a with a screen display 231b that displays an illustrative user interface with functions to allow a mobile device user to create a unique biometric UAP in the alarm and calendar event management system, if no controlling UAP currently exists inside the alarm and calendar event management system.

Referring to FIG. 23B, the alarm and calendar event management system awaits the user's action to provide the user's biometric information through one of the available sensors that may include, but not limited to sensors capturing the user's thumbprint, iris information, voice print, and etc. through one of the commonly available and prevailing biometric technologies.

After that, while following the alarm and calendar event management system instructions 231e, the alarm and calendar event management system user starts the process of creating a biometric UAP, through one of the suitable and commonly available biometric or eye mapping technologies via a designated biometric sensor spot(s) (231c, 231d) on the mobile device, the mobile device being equipped with commonly prevailing biometric detection technology, until the alarm and calendar event management system successfully captures the user's biometric profile.

Then, the alarm and calendar event management system captures the user's actions, and associates and incorporates the captured information to be used as the alarm and calendar event management system's Biometric UAP for the current alarm and calendar event management system user, followed by refreshing the mobile device display with a notification message of successful capture of the controlling UAP, while the awaiting user's acknowledgement.

Then, the alarm and calendar event management system's user acknowledges the alarm and calendar event management system's notification message, after which the alarm and calendar event management system refreshes the mobile device display with a calling interface that called the user interface as aforementioned.

In another embodiment, the alarm and calendar event management system provides an appropriate user interface on the mobile device display with functions to allow the mobile device user to release (i.e. delete from the alarm and calendar event management system) a Non-biometric Controlling UAP from the alarm and calendar event management system.

As a part of validating current user's profile, the alarm and calendar event management system user starts the process of providing his/her own UAP information by typing in a username and associated password, followed by confirming the entered information. Then, the alarm and calendar event management system captures the user's actions, followed by validating the user entered information with information currently stored in the alarm and calendar event management systems' controlling UAP.

Upon successful validation, the alarm and calendar event management system refreshes the mobile device display with a user interface with functions available for user to start the process of releasing controlling UAP from the alarm and calendar event management system. The alarm and calendar event management system user engages an appropriate touch sensitive switch associated to the controlling UAP of the alarm and calendar event management system, for the purpose of releasing the controlling UAP from alarm and calendar event management system, followed by confirming the user's action. Then, the alarm and calendar event management system captures the user's actions, and clears the Non-biometric Controlling UAP for the current alarm and calendar event management system, followed by refreshing the mobile device display with a notification message to the alarm and calendar event management system's user of a successful release of Non-biometric Controlling UAP, while awaiting the user's acknowledgement.

The alarm and calendar event management system user acknowledges the alarm and calendar event management system's notification message, after which the alarm and calendar event management system refreshes the mobile device display with the calling interface that called the user interface as aforementioned.

In another embodiment, the alarm and calendar event management system provides an appropriate user interface on the mobile device display with functions to allow mobile device user to release (i.e. delete from the alarm and calendar event management system) a Biometric Controlling UAP from the alarm and calendar event management system.

The alarm and calendar event management system user proceeds to provide his or her user's biometric information through one of designated biometric sensor spot(s) (231c, 231d) on the mobile device that may include, but not limited to capturing user's thumbprint, iris information, voice print, and etc. for validation by the alarm and calendar event management system. The alarm and calendar event management system captures user's actions, followed by validating the user captured information with information currently stored in the alarm and calendar event management system's Biometric Controlling UAP.

Upon successful validation, the alarm and calendar event management system refreshes the mobile device display with a user interface with functions available for user to start the process of releasing existing Biometric Controlling UAP from the alarm and calendar event management system.

After that, the alarm and calendar event management system user engages an appropriate touch sensitive switch associated to the Biometric Controlling UAP of the alarm and calendar event management system, for the purpose of releasing the Biometric Controlling UAP from the alarm and calendar event management system, followed by confirming the user's action.

Then, the alarm and calendar event management system captures user's actions, and clears (i.e. deletes) the Biometric Controlling UAP for the current alarm and calendar event management system, followed by refreshing the mobile device display with a notification message to the alarm and calendar event management system's user of a successful release of the Biometric Controlling UAP, while awaiting the user's acknowledgement.

After that, the alarm and calendar event management system's user acknowledges the alarm and calendar event management system's notification message, after which the alarm and calendar event management system refreshes the mobile device display with the calling interface that called the user interface as aforementioned.

In the embodiment depicted in FIG. 24, an alarm and calendar event management system provides an appropriate user interface on a mobile device 240a with a mobile device display 240b with functions available to the mobile device user, through the alarm and calendar event management system's touch sensitive functionality, “Auto-Synchronization of User Data Instance” feature 240c. When the “Auto-Synchronization of User Data Instance” feature 240c is activated or switched on (i.e. indicator 240d reads “ON”), the alarm and calendar event management system will be interpreted as an alarm and calendar event management system that allows automatic synchronization, via an established wireless connection (e.g. via a WAN) on the mobile device housing the alarm and calendar event management system, of its user data instance among multiple mobile devices sharing the same controlling UAP.

The mobile device of the alarm and calendar event management system is known to hold the most updated user data instance (i.e. with the most recent date and time stamp, among other devices sharing the same controlling UAP, with the date and time stamp employing dating with reference to Greenwich GMT time) at a specific point in time, will be the device (i.e. the originating mobile device) from which its alarm and calendar event management system's user data instance, via a central cloud-based repository storage, will be synchronized among other multiple devices sharing the same controlling UAP as the originating mobile device.

The synchronization activities of the alarm and calendar event management system's user data instance begin when data communication is established with a designated cloud-based server that houses a central repository storage where the most current user data instance will be kept for the purpose of synchronizing user data instance among mobile device devices that share the same controlling UAP, through an appropriate wireless technology (e.g. WIFI via a wide area network (WAN)).

The actual process of synchronization of the user data instance between two or more devices starts upon (i) a mobile device user starting up of the alarm and calendar event management system with its “Auto-Synchronization of User Data Instance” feature 240c activated or (ii) the mobile device user using an individual mobile device (i.e. a requesting device) requesting a manual synchronization request of user data instance among other mobile devices sharing the same controlling UAP as the requesting device, through engaging touch sensitive “Request for Synchronization of User Data Instance” link 240e.

After that, the alarm and calendar event management system responds by (i) starting the process of requesting for opening a secured interface connection, via appropriate mobile device's communication interface channel and via an already established wireless connection (e.g. via a WAN) on the mobile device housing the alarm and calendar event management system, to the cloud based repository storage server.

Following successful connection with the repository storage server, the alarm and calendar event management system verifies its user data instance's date and time stamp with the one located in the repository storage server location.

Following completion of the verification activities, if the alarm and calendar event management system determines that the date and time stamp of the current alarm and calendar event management system is a date and time later than the date and time stamp of the user data instance that is currently located in the repository storage server, the alarm and calendar event management system proceeds with replacing the user data instance located in the central repository storage server with the one in the current alarm and calendar event management system; if the alarm and calendar event management system determines that the date and time stamp of current alarm and calendar event management system is a date and time before the date and time stamp of the user data instance that is currently located in the repository storage server, the alarm and calendar event management system proceeds with replacing the user data instance located in the current alarm and calendar event management system with the one located in the central repository storage. If the alarm and calendar event management system determines that the date and time stamp of current alarm and calendar event management system is a date and time that is exactly as the date and time stamp of the user data instance that is currently located in the repository storage server, the alarm and calendar event management system takes no action on the synchronization.

Upon completion of the aforementioned activities, the alarm and calendar event management system follows up with a notification message on the mobile device display of a successful synchronization, after which the alarm and calendar event management system sends a request, via the mobile device's appropriate communication channel interface, to closely communicate with the central repository storage server, which eventually culminates in such communication being closed.

In another embodiment, while the alarm and calendar event management system's “Auto-Synchronization of User Data Instance” feature 240c is activated (i.e. indicator 240d reads “ON”), along with an available wireless connection (e.g. via a WAN) established on the mobile device housing the alarm and calendar event management system, and with a mobile device user attempting to update an alarm and calendar event management system's calendar or recurring alarm related event with impact on alarm and calendar event management system's prevailing recurring alarm. The alarm and calendar event management system, as a part of the mechanism ensuring the integrity of the synchronized data being maintained and ensuring the repository storage sever is updated with the most accurate user data instance, proceeds with: (i) verifying, through the mobile device's appropriate communication interface channel, whether there is a currently locking mechanism in effect in the central repository storage server location, (ii) upon confirming there is a currently locking mechanism in effect in the repository storage server, proceeding with a notification message to the mobile device user and preventing the mobile device user from further proceeding with engagement of such calendar or recurring alarm events; and (iii) upon confirming there is currently no locking mechanism in effect in the repository storage server, prior to allowing the mobile device user to update calendar related or recurring alarm events, requesting a locking mechanism to be in effect in the repository storage server so that any other concurrent request(s) (e.g. arising from other devices) to update the related events will be prevented during the time in which the current mobile device user is allowed to engage the requested event.

It is noted that the locking mechanism, in the context of the alarm and calendar event management system, is similar to the commonly used database/record/file locking concept where a database or record is being locked while it is being updated to prevent others from making update to the same record or database at the same time. In the context of the alarm and calendar event management system, the locking mechanism takes on the same meaning as locking a database or record in that the user data instance file is being locked at the repository location so that the update access to it will be denied while an update is being made somewhere else that may potentially alter the user data instance at the repository server location. Once a locking mechanism is removed from the user data instance at the repository location, update requests to it will be allowed but subject to access rights given to such requests.

Upon the locking mechanism being granted at the repository storage server arising from the alarm and calendar event management system's request, followed by an appropriate notification originating from the central repository storage server, the alarm and calendar event management system proceeds with allowing the mobile device user to start updating calendar related or recurring alarm related events.

During the update activities by the mobile device user for the calendar related or recurring alarm events, who are granted the permission to update such events, the mobile device user confirms such events (saving events), or exit without confirming with the alarm and calendar event management system about such calendar related or recurring alarm events.

After that, the alarm and calendar event management system proceeds with (i) updating the alarm and calendar event management system's user data instance, followed by (ii) replacing the user data instance located in the central repository storage server with the respective one in the current alarm and calendar event management system with the currently secured interface connection with the repository storage server; and (iii) proceeding with activities described hereafter. After that, the alarm and calendar event management system proceeds with requesting the current locking mechanism in the repository storage server to be released. Such request is granted and resulting in the locking mechanism being released at the repository storage server.

According to another embodiment of the present patent application, an alarm and calendar event management method includes: setting up a plurality of recurring alarms, each recurring alarm being configured to fire at a predetermined date and time periodically; downloading a plurality of country holidays of a country that matches the time zone in which the mobile device is physically located; setting up a plurality of personal holidays; selectively disabling the recurring alarms on a date based on the country holidays, the personal holidays, or a configuration of a user; and selectively reinstating the recurring alarms on a date based on a configuration of the user.

According to another embodiment of the present patent application, an alarm and calendar event management system for a mobile device includes: means for setting up a recurring alarm, the recurring alarm being configured to fire at a predetermined date and time periodically; means for downloading a plurality of country holidays of a country that matches the time zone in which the mobile device is physically located; means for selectively disabling the recurring alarm on a date based on the country holidays or a configuration of a user; and means for selectively reinstating the recurring alarm on a date based on a configuration of the user.

According to another embodiment of the present patent application, an alarm and calendar event management system for a mobile device includes means for setting up a plurality of recurring alarms through one single recurring alarm setup, each recurring alarm being configured to fire at a predetermined date and time periodically; means for downloading a plurality of country holidays of a country that matches the mobile device's current time zone in which the mobile device is physically located; means for automatically recognizing a plurality of previously downloaded country holidays of a country that matches the mobile device's current time zone in which the mobile device is physically located; means for setting up a plurality of personal holidays; means for selectively disabling the recurring alarms on a date based on the country holidays, the personal holidays, or a configuration of a user without altering the single recurring alarm setup; means for selectively reinstating the recurring alarms on a date based on a configuration of the user without altering the single recurring alarm setup; and means for synchronizing the recurring alarms and related calendar triggered events with other mobile devices.

The means for selectively disabling the recurring alarms may be configured either to disable the recurring alarms on all the country holidays, or to allow the recurring alarms on all the country holidays.

The means for setting up the recurring alarms may be configured to configure the recurring alarms to fire in a plurality of periodical shift cycles in a looped fashion, on dates corresponding to fixed chronological days in each shift cycle, and at a time that is associated with an individual periodic shift cycle that is prevailing on the day of the recurring alarm firing.

The alarm and calendar event management system may further include means for synchronizing a user data instance with a cloud based server. The user data instance is a consolidated data file that primarily holds a set of recurring alarm events and related calendar events that impact such recurring alarm events.

The means for synchronizing the user data instance may be configured to authenticate a user by recognizing a predetermined controlling user authentication profile, and to synchronize the user data instance with mobile devices that share similar controlling user authentication profiles.

According to yet another embodiment, an alarm and calendar event management method for a mobile device includes: setting up a plurality of recurring alarms through one single recurring alarm setup, each recurring alarm being configured to fire at a predetermined date and time periodically; downloading a plurality of country holidays of a country that matches the mobile device's current time zone in which the mobile device is physically located; setting up a plurality of personal holidays; selectively disabling the recurring alarms on a date based on the country holidays, the personal holidays, or a configuration of a user without altering the single recurring alarm setup; and selectively reinstating the recurring alarms on a date based on a configuration of the user without altering the single recurring alarm setup.

In the step of selectively disabling the recurring alarm, disabling the recurring alarms on all the country holidays, or allowing the recurring alarms on all the country holidays.

In the step of setting up the recurring alarms, the recurring alarms are configured to fire in a plurality of periodical shift cycles in a looped fashion, on user's selected dates that coincide with the mobile device's current system dates, of any respective periodical shift cycle that is currently prevailing at time of the recurring alarms' firing, and at user's specified time associated with the respective periodic shift cycle.

According to still another embodiment of the present patent application, an alarm and calendar event management system for a mobile device includes: means for setting up a recurring alarm through one single recurring alarm setup, the recurring alarm being configured to fire at a predetermined date and time periodically; means for downloading a plurality of country holidays of a country that matches the time zone in which the mobile device is physically located; means for selectively disabling the recurring alarm on a date based on the country holidays or a configuration of a user without altering the single recurring alarm setup; and means for selectively reinstating the recurring alarm on a date based on a configuration of the user without altering the single recurring alarm setup.

In the above embodiments, it is noted that a mobile device that houses the alarm and calendar event management system may be any portable electronic device, including but not restricted to smart phones (e.g. iPhones, Samsung Mobile Phones, Android based Mobile Phones), Mobile Audio and Visual Devices (such as iPod, Tablets like iPad, Samsung Galaxy Tablets, etc.). Furthermore, the mobile device may also include any wearable device (e.g. watch-like devices, wrist-watch devices, arm-band devices, and etc.) as well as any portable electronic devices designed to sit/rest on tables or similar flat surfaces (e.g. digital photo frame devices, digital alarm clock devices, and etc.).

It is also understood that the mobile device may further include necessary components such as processors, memory circuitry, controllers, interfaces, sensors, sub-systems, etc., including but not restricted to the following components: (i) a communication circuitry operable to: allow communication over a cellular network (e.g. GSM, GPRS, etc.), a WIFI network, and a Bluetooth network; receive downloads and/or upgrades from one or more external server(s) related to: the single application functionalities, calendar and alarm related data, country holidays related data, the mobile device user's preferences, and etc.; (ii) one or more sensor component(s) with sensor technologies with capabilities including, but not restricted to common and prevailing: tactile sensing, infrared sensing, and eye tracking technologies that are able to be used to detect and respond to movements such as a person's hand, finger, or pen stylus making single and multi-touch swiping and tapping motion on a mobile device display; hovering of a person's finger or hand doing a wave-like or flipping gestures right on top of mobile device without touching the screen display; and a person's eye fixating on mobile device display; (iii) a clock and calendar date circuitry system operable to identify the single application's current time, calendar days, and calendar dates for the purpose of managing individual alarms and other calendar events (e.g. for recurring alarms, personal alarms, schedules, anniversaries, country holidays, personal holidays); (iv) an I/O (input/output) subsystem with the appropriate components (e.g. I/O touchscreen controllers coupled to a touchscreen, other I/O controllers) operable to receive user inputs and/or entries and/or selections for performing appropriate functions allowed within the single application; (v) a touchscreen display operable to display appropriate graphical user interfaces necessary for a user to interact with the single application and for the user to perform I/O related functions within the context of the single application; (vi) a storage component operable to: store a user's calendar and alarm events related data and the user's preferences. An audio subsystem component operable to facilitate: alarm firing and pre-alert audible notification functions; voice-enabled functions such as voice recognition function via a mobile device's microphone, speakers, internal earpiece, an external earpiece that is connected to a mobile device's earpiece connector; (vii) a machine-readable media (within the mobile device that houses the single application) including machine-readable instructions recorded thereon for: determining a next scheduled calendar event or alarm event for a specific target date and/or target time; determining the mobile device in possession by a user is powered on at the appointed target date and time for a next scheduled calendar event or alarm event; at the appointed target date and target time for a next scheduled calendar event or alarm event, as per the recorded machine-readable instructions, executing the firing or skipping of the scheduled alarm event or the firing of a pre-alert notification of the scheduled calendar event.

While the present patent application has been shown and described with particular references to a number of embodiments thereof, it should be noted that various other changes or modifications may be made without departing from the scope of the present invention.

What is claimed is:

1. An alarm and calendar event management system for a mobile device, the system comprising:
means for setting up a plurality of recurring alarms through one single recurring alarm setup, each recurring alarm being configured to fire at a predetermined date and time periodically;
means for downloading a plurality of country holidays of a country that matches the mobile device's current time zone in which the mobile device is physically located;
means for automatically recognizing a plurality of previously downloaded country holidays of a country that matches the mobile device's current time zone in which the mobile device is physically located;
means for setting up a plurality of personal holidays;
means for selectively disabling the recurring alarms on a date based on the country holidays, the personal holidays, or a configuration of a user without altering the single recurring alarm setup;
means for selectively reinstating the recurring alarms on a date based on a configuration of the user without altering the single recurring alarm setup; and
means for synchronizing the recurring alarms and related calendar triggered events with other mobile devices.

2. The alarm and calendar event management system of claim 1, wherein the country holidays are associated with the same calendar year as the mobile device's operating system, and downloaded from a remote server.

3. The alarm and calendar event management system of claim 2, wherein the means for selectively disabling the recurring alarms are configured either to disable the recurring alarms on all the country holidays, or to allow the recurring alarms on all the country holidays.

4. The alarm and calendar event management system of claim 2 further comprising means for determining a subset of the country holidays as generally observed country holidays based on a built-in holiday rules engine, a user's preset criteria, and time zone information of the mobile device, wherein the means for selectively disabling the recurring alarms are configured to disable the recurring alarms on all generally observed country holidays.

5. The alarm and calendar event management system of claim 1, wherein the means for selectively disabling the recurring alarms are configured to enable the user to disable the recurring alarms on a specific date via a virtual calendar month display view, and the means for selectively reinstating the recurring alarms are configured to enable the user to reinstate the recurring alarms on a specific date via a virtual calendar month display view.

6. The alarm and calendar event management system of claim 1 further comprising means for establishing a universal alarm setting, wherein the means for setting up the recurring alarms are configured to set up new recurring alarms inheriting the universal alarm setting.

7. The alarm and calendar event management system of claim 6, wherein the universal alarm setting comprises a snooze parameter, a sound parameter, a volume setting, and a vibrate setting.

8. The alarm and calendar event management system of claim 1, wherein the means for setting up the recurring alarms are configured to configure the recurring alarms to fire in a plurality of periodical shift cycles in a looped fashion, on dates corresponding to fixed chronological days in each shift cycle, and at a time that is associated with an individual periodic shift cycle that is prevailing on the day of the recurring alarm firing.

9. The alarm and calendar event management system of claim 1, wherein the means for selectively disabling the recurring alarms are configured to disable the recurring alarms on a specific date by an instruction from the user through voice interaction, and the means for selectively reinstating the recurring alarms are configured to reinstate the recurring alarms on a specific date by an instruction from the user through voice interaction.

10. The alarm and calendar event management system of claim 1 further comprising means for synchronizing a user data instance with a cloud based server, wherein the user data instance is a consolidated data file that primarily holds a set of recurring alarm events and related calendar events that impact such recurring alarm events.

11. The alarm and calendar event management system of claim 10, wherein the means for synchronizing the user data instance are configured to authenticate a user by recognizing a predetermined controlling user authentication profile, and to synchronize the user data instance with mobile devices that share similar controlling user authentication profiles.

12. An alarm and calendar event management method for a mobile device, the method comprising:
setting up a plurality of recurring alarms through one single recurring alarm setup, each recurring alarm being configured to fire at a predetermined date and time periodically;
downloading a plurality of country holidays of a country that matches the mobile device's current time zone in which the mobile device is physically located;
setting up a plurality of personal holidays;
selectively disabling the recurring alarms on a date based on the country holidays, the personal holidays, or a configuration of a user without altering the single recurring alarm setup; and
selectively reinstating the recurring alarms on a date based on a configuration of the user without altering the single recurring alarm setup.

13. The alarm and calendar event management method of claim 12, wherein the country holidays are associated with the same calendar year as the mobile device's operating system, and downloaded from a remote server.

14. The alarm and calendar event management method of claim 13, wherein in the step of selectively disabling the recurring alarm, the recurring alarms on all the country holidays are disabled or allowed.

15. The alarm and calendar event management method of claim 14 further comprising determining a subset of the country holidays as generally observed country holidays based on a built-in holiday rules engine, a user's preset criteria, and time zone information of the mobile device, wherein the step of selectively disabling the recurring alarms comprises disabling the recurring alarms on all generally observed country holidays.

16. The alarm and calendar event management method of claim 12, wherein the step of selectively disabling the recurring alarms comprises enabling the user to disable the recurring alarms on a specific date via a virtual calendar month display view, and the step of selectively reinstating the recurring alarms comprises enabling the user to reinstate the recurring alarms on a specific date via a virtual calendar month display view.

17. The alarm and calendar event management method of claim 12, wherein in the step of setting up the recurring alarms, the recurring alarms are configured to fire in a plurality of periodical shift cycles in a looped fashion, on user's selected dates that coincide with the mobile device's current system dates, of any respective periodical shift cycle that is currently prevailing at time of the recurring alarms' firing, and at user's specified time associated with the respective periodic shift cycle.

18. An alarm and calendar event management system for a mobile device, the system comprising:
means for setting up a recurring alarm through one single recurring alarm setup, the recurring alarm being configured to fire at a predetermined date and time periodically;
means for downloading a plurality of country holidays of a country that matches the time zone in which the mobile device is physically located;
means for selectively disabling the recurring alarm on a date based on the country holidays or a configuration of a user without altering the single recurring alarm setup; and
means for selectively reinstating the recurring alarm on a date based on a configuration of the user without altering the single recurring alarm setup.

19. The alarm and calendar event management system of claim 18, wherein the means for selectively disabling the recurring alarm are configured either to disable the recurring alarm on all the country holidays, or to allow the recurring alarm on all the country holidays.

20. The alarm and calendar event management system of claim 18, wherein the means for setting up the recurring alarm are configured to configure the recurring alarm to fire in a plurality of periodical shift cycles in a looped fashion, on dates corresponding to fixed chronological days in each shift cycle, and at a time that is associated with an individual periodic shift cycle that is prevailing on the day of the recurring alarm firing.
